(19) United States
(12) Patent Application Publication
(10) Pub. No.: US 2009/0047058 A1
(43) Pub. Date: Feb. 19, 2009

(54) Binder

(76) Inventor: Toru Yoshie, Tokyo (JP)

Correspondence Address: DRINKER BIDDLE & REATH (DC), 1500 K STREET, N.W., SUITE 1100, WASHINGTON, DC, 20005-1209, US

(21) Appl. No.: 11/919,973

(22) PCT Filed: May 11, 2006
(86) PCT No.: PCT/JP2006/309501

§ 371 Date: Nov. 6, 2007

(30) Foreign Application Priority Data
May 11, 2005 (JP) 2005-139122
May 11, 2005 (JP) 2005-139123

(51) Int. Cl. B42F 13/00

(52) U.S. Cl. 402/75

(57) ABSTRACT

A binder 1A is provided with: ring portions 3A to be inserted into binding holes formed in sheets of paper to bind the sheets of the paper; and a spine portion 2A which is configured by a member independent from the ring portions 3A and to which the ring portions 3A are attached. Each ring portion 3A has a plurality of engagement holes 6A which are attached to the spine portion 2A and arranged in a longitudinal direction of each ring portion 3A, and is cut depending on the number of the sheets of paper to be bound. The spine portion 2A has engagement protrusions 5A corresponding to the binding holes in the sheets of paper and the ring engagement holes 6A at both ends of each loop-shaped ring portion are attached to the engagement portions 5A.

### TECHNICAL FIELD

The present invention relates to a binder that binds a plurality of sheets of paper through which binding holes are formed. Specifically, the binder can bind the sheets of paper in an optimum shape regardless of a thickness of a formed document by allowing a loop diameter of a ring portion for binding paper to be varied or selected.

### BACKGROUND ART

A binder for binding sheets of paper through which binding holes are formed has ring-shaped members to be inserted into the binding holes and a spine portion supporting the plurality of ring-shaped members to correspond to the binding holes.

Conventionally, there is proposed a binder in which a ring-shaped member and a spine portion are provided as independent components (for example, see JP-U-3008291). In addition, there is proposed a binder in which a ring-shaped member and a spine portion are configured as an incorporated component (for example, see JP-A-07-009789 and JP-A-2000-289376).

In general, when the number of sheets of paper is small, a diameter of the ring-shaped member needs to be small, but when the number of sheets of paper is large, the diameter of the ring-shaped member needs to be large.

Therefore, there is a problem in the conventional binders in that a plurality of types of components should be prepared depending on the number of sheets of paper to be bound. That is, in the binder in which the ring-shaped member and the spine portion are provided as the independent components, a plurality of types of ring-shaped members with different diameters should be prepared. In contrast, in the binder in which the ring-shaped member and the spine portion are provided as the incorporated components, a plurality of types of binders having the different ring-shaped members should be prepared.

In addition, when the number of holes is different depending on the sheets of paper types, a plurality of types of binders having the different number of the ring-shaped members should be prepared.

Accordingly, there may be an occurrence that a manufacturing cost increases from a reason that the plurality of types of components are manufactured or a managing cost increases from a reason that the plurality of types of components are managed as inventory products.

### DISCLOSURE OF THE INVENTION

One or more embodiments of the invention provide a binder that can correspond to a difference in the number of sheets of paper to be bound.

The binder according to one or more embodiments of the invention is provided with: ring portions to be inserted into binding holes on sheets of the paper for binding the sheets of paper; and a spine portion which is provided as a member independent from the ring portions and to which the ring portions are attached. In the ring portions, plurality of ring engagement portions attached to the spine portion are arranged in a longitudinal direction of the ring portions. Further, in the spine portion, spine engagement portions to which the ring engagement portions at both ends including one end and the other end of the loop-shaped ring portions are attached are provided so as to correspond to the binding holes of the sheets of paper.

In the binder according to one or more embodiments of the invention, the ring portions are cut in a desired length depending on the number of sheets of the paper to be bound. For example, when the number of sheets of the paper to be bound is small, the ring portions are cut short, and alternatively, when the number of sheets of the paper to be bound is large, the ring portions are cut long.

In the ring portions, the plurality of ring engagement portions are arranged in a longitudinal direction of the ring portions. Therefore, irrespective of the cut length of each ring portion, the ring engagement portions are placed at both ends thereof.

Accordingly, by inserting the ring portion into the binding hole and attaching a ring engagement portion on the one end and a ring engagement portion on the other end of the loop-shaped ring portion to the spine engagement portion, the sheets of paper can be bound by the ring portion in a loop shape attached to the spine portion.

The ring portions are cut depending on the number of sheets of paper to be bound. Accordingly, by preparing one type of ring portions, the ring portions with a small loop diameter are formed when the number of sheets of paper is small, and the ring portions with a large loop diameter are formed when the number of sheets of paper is large.

In the binder according to one or more embodiments of the invention, the ring portions which are cut in an arbitrary length and are configured to the loop shape are attached to the spine portion and bind the sheets of paper to form a document. Accordingly, when one type of ring portions is prepared, the ring portions can be configured to have the loop diameters depending on the thickness of the document. As a result, the plurality of types of components should not be prepared depending on the thickness of a document.

The binder according to one or more embodiments of the invention is provided with: the ring portions to be inserted into binding holes on the sheets of paper for binding the sheets of the paper; and the spine portion which is provided as a member independent from the ring portions and to which the ring portions are attached. In each ring portion, the plurality of ring engagement portions to be attached to the spine portion are provided at both ends thereof in a longitudinal direction of each ring portion. Further, in the spine portion, the spine engagement portions to which both ends of the loop-shaped ring portions are attached are provided so as to correspond to the binding holes of the sheet of paper.

In the binder according to one or more embodiments of the invention, the ring engagement portions at both ends of each loop-shaped ring portion so as to be inserted into the binding holes of paper are attached to the spine engagement portions of the spine portion. Accordingly, each ring portion, which is fixed on the spine portion so that the loop shape is formed, can bind the sheets of the paper.

The ring portions and the spine portion are provided as independent components. Accordingly, by preparing the ring portions with different lengths, the binder that has the ring portions with different loop diameters can be configured by using common spine portion.

In the binder according to one or more embodiments of the invention, the ring portions for binding sheets of paper and the spine portion for supporting the plurality of ring portions are provided as the independent components. Accordingly, by preparing the ring portions with different lengths, the binder that has the loop diameters depending on the number of sheets of paper can be configured by using the common spine portion.

Since the number of the ring portions attached to the spine portion can be arbitrarily selected, it is possible to correspond to a difference in the number of the binding holes of paper by using the common spine portion.

Accordingly, the number of components to be prepared in correspondence with the thickness of the document can be reduced by using a common spine portion.

Other aspects and advantages of the invention will be apparent from the following description and the appended claims.

### BRIEF DESCRIPTION OF THE DRAWINGS

FIG. 1 is a perspective view illustrating an example of an assembled binder according to a first exemplary embodiment.

FIG. 2A is a front view illustrating an example of a binder according to the first exemplary embodiment when it is used.

FIG. 2B is a side view illustrating an example of the using binder according to the first exemplary embodiment.

FIG. 3A is an exploded block diagram illustrating a spine portion of the binder according to the first exemplary embodiment before the binder is used.

FIG. 3B is an exploded block diagram illustrating ring portions of the binder according to the first exemplary embodiment before the binder is used.

FIG. 4A is a block diagram illustrating an example of the binder according to the first exemplary embodiment used when sheets of paper is small.

FIG. 4B is a block diagram illustrating an example of the binder according to the first exemplary embodiment used when sheets of paper is large.

FIG. 5 is a perspective view illustrating an example of an assembled binder according to a second exemplary embodiment.

FIG. 6A is a front view illustrating an example of a binder according to the second exemplary embodiment when it is used.

FIG. 6B is a side view illustrating an example of the binder according to the second exemplary embodiment when it is used.

FIG. 7A is an exploded block diagram illustrating a spine portion of the binder according to the second exemplary embodiment before the binder is used.

FIG. 7B FIG. 3B is an exploded block diagram illustrating ring portions of the binder according to the second exemplary embodiment before the binder is used.

FIG. 8A is a block diagram illustrating an example of the binder according to the second exemplary embodiment used when sheets of paper is small.

FIG. 8B is a block diagram illustrating an example of the binder according to the second exemplary embodiment used when sheets of paper is large.

FIG. 9 is a perspective view illustrating an example of an assembled binder according to a third exemplary embodiment.

FIG. 10A is a front view illustrating an example of a binder according to the third exemplary embodiment when it is used.

FIG. 10B is a side view illustrating an example of the binder according to the third exemplary embodiment when it is used.

FIG. 11A is an exploded block diagram illustrating a spine portion of the binder according to the third exemplary embodiment before the binder is used.

FIG. 11B is an exploded block diagram illustrating ring portions of the binder according to the third exemplary embodiment before the binder is used.

FIG. 12A is a block diagram illustrating an example of the binder according to the third exemplary embodiment used when sheets of paper is small.

FIG. 12B is a block diagram illustrating an example of the binder according to the third exemplary embodiment used when sheets of paper is large.

FIG. 13 is a perspective view illustrating an example of an assembled binder according to a fourth exemplary embodiment.

FIG. 14A is a front view illustrating an example of a binder according to the fourth exemplary embodiment when it is used.

FIG. 14B is a side view illustrating an example of the binder according to the fourth exemplary embodiment when it is used.

FIG. 15A is an exploded block diagram illustrating a spine portion of the binder according to the fourth exemplary embodiment before the binder is used.

FIG. 15B is an exploded block diagram illustrating ring portions of the binder according to the fourth exemplary embodiment before the binder is used.

FIG. 16A is a block diagram illustrating an example of the binder according to the fourth exemplary embodiment used when sheets of paper is small.

FIG. 16B is a block diagram illustrating an example of the binder according to the fourth exemplary embodiment used when sheets of paper is large.

FIG. 17 is a perspective view illustrating an example of an assembled binder according to a fifth exemplary embodiment.

FIG. 18A is a front view illustrating an example of a binder according to the fifth exemplary embodiment when it is used.

FIG. 18B is a side view illustrating an example of the binder according to the fifth exemplary embodiment when it is used.

FIG. 19A is an exploded block diagram illustrating a spine portion of the binder according to the fifth exemplary embodiment before the binder is used.

FIG. 19B is an exploded block diagram illustrating ring portions of the binder according to the fifth exemplary embodiment before the binder is used.

FIG. 20A is a block diagram illustrating an example of the binder according to the fifth exemplary embodiment used when sheets of paper is small.

FIG. 20B is a block diagram illustrating an example of the binder according to the fifth exemplary embodiment used when sheets of paper is large.

FIG. 21A is an explanatory diagram illustrating an example of a process of manufacturing a binder according to the invention and showing that a ring portion is inserted into a binding hole of paper from a ring portion supply body.

FIG. 21B is an explanatory diagram illustrating an example of the process of manufacturing the binder according to the invention and showing that the ring portion is cut.

FIG. 21C is an explanatory diagram illustrating an example of the process of manufacturing the binder according to the invention and showing that the ring portion engages with a spine portion.

FIG. 22 is a perspective view illustrating an example of an assembled binder according to a sixth exemplary embodiment.

FIG. 23A is a front view illustrating an example of a binder according to the sixth exemplary embodiment when it is used.

FIG. 23B is a side view illustrating an example of the binder according to the sixth exemplary embodiment when it is used.

FIG. 24A is an exploded block diagram illustrating a spine portion of the binder according to the sixth exemplary embodiment before the binder is used.

FIG. 24B is an exploded block diagram illustrating ring portions of the binder according to the sixth exemplary embodiment before the binder is used.

FIG. 25A1 is a block diagram illustrating an example of the binder according to the sixth exemplary embodiment and a side view illustrating a ring portion, a spine portion, and paper when sheets of paper is small.

FIG. 25A2 is a block diagram illustrating an example where the binder according to the sixth exemplary embodiment is used when sheets of paper is small.

FIG. 25B1 is a block diagram illustrating an example of the binder according to the sixth exemplary embodiment and a side view illustrating the ring portion, the spine portion, and the sheets of paper when sheets of paper is large.

FIG. 25B2 is a block diagram illustrating an example of the binder according to the sixth exemplary embodiment used when sheets of paper is large.

FIG. 26 is a perspective view illustrating an example of an assembled binder according to a seventh exemplary embodiment.

FIG. 27A is a front view illustrating an example of a binder according to the seventh exemplary embodiment when it is used.

FIG. 27B is a side view illustrating an example of the binder according to the seventh exemplary embodiment when it is used.

FIG. 28A is an exploded block diagram illustrating a spine portion of the binder according to the seventh exemplary embodiment before the binder is used.

FIG. 28B is an exploded block diagram illustrating ring portions of the binder according to the seventh exemplary embodiment before the binder is used.

FIG. 29A1 is a block diagram illustrating an example of the binder according to the seventh exemplary embodiment and a side view illustrating a ring portion, a spine portion, paper when sheets of paper are small.

FIG. 29A2 is a block diagram illustrating an example of the binder according to the seventh exemplary embodiment and a side view illustrating the ring portion when sheets of paper are small.

FIG. 29B1 is a block diagram illustrating an example of the binder according to the seventh exemplary embodiment and a side view illustrating the ring portion, the spine portion, and the sheets of paper when sheets of paper is large.

FIG. 29B2 is a block diagram illustrating an example of the binder according to the seventh exemplary embodiment and a side view illustrating the ring portion when sheets of paper are large.

FIG. 30 is a perspective view illustrating an example of an assembled binder according to an eighth exemplary embodiment.

FIG. 31A is a front view illustrating an example of a binder according to the eighth exemplary embodiment when it is used.

FIG. 31B is a side view illustrating an example of the binder according to the eighth exemplary embodiment when it is used.

FIG. 32A is an exploded block diagram illustrating a spine portion of the binder according to the eighth exemplary embodiment before the binder is used.

FIG. 32B is an exploded block diagram illustrating ring portions of the binder according to the eighth exemplary embodiment before the binder is used.

FIG. 33A1 is a block diagram illustrating an example of the binder according to the eighth exemplary embodiment and a side view illustrating a ring portion, a spine portion, paper when sheets of paper are small.

FIG. 33A2 is a block diagram illustrating an example of the binder according to the eighth exemplary embodiment and a side view illustrating the ring portion when sheets of paper are small.

FIG. 33B1 is a block diagram illustrating an example of the binder according to the eighth exemplary embodiment and a side view illustrating the ring portion, the spine portion, and the sheets of paper when sheets of paper is large.

FIG. 33B2 is a block diagram illustrating an example of the binder according to the eighth exemplary embodiment and a side view illustrating the ring portion when sheets of paper are large.

FIG. 34A is a block diagram illustrating a modified example of an engagement protrusion according to each exemplary embodiment.

FIG. 34B is a block diagram illustrating a modified example of an engagement hole according to each exemplary embodiment.

### DESCRIPTION OF REFERENCE NUMERALS AND SIGNS

1A, 1B, 1C, 1D, 1E, 11A, 11B, 11C: BINDER
2A, 2B, 2C, 2D, 2E, 12A, 12B, 12C: SPINE PORTION
3A, 3B, 3D, 3E, 13A, 13B, 13C, 13: RING PORTION
4, 14: PAPER
4a, 14a: BINDING HOLE
5A, 5B, 5CL, 5CR, 8, 5, 15A, 15B, 18, 19: ENGAGEMENT PROTRUSION
6A, 6B, 7L, 7R, 6, 16A, 16B, 17L, 17R, 110: ENGAGEMENT HOLE

### BEST MODE FOR CARRYING OUT THE INVENTION

Hereinafter, exemplary embodiments of a binder according to the invention will be described with reference to the drawings.

### Configuration Example of Binder According to First Exemplary Embodiment

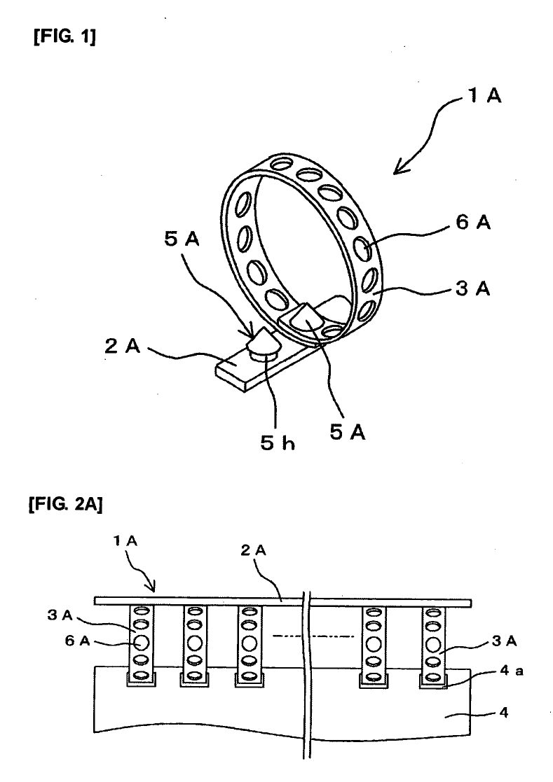

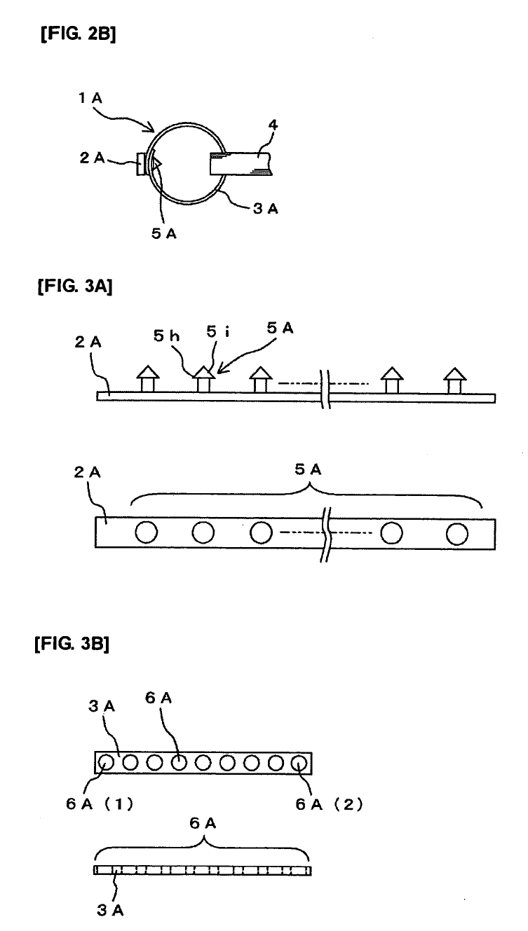

FIG. 1 is a perspective view illustrating an example of an assembled binder 1A according to a first exemplary embodiment. FIGS. 2A and 2B are top views illustrating an example of the using binder 1A according to the first exemplary embodiment. FIGS. 3A and 3B are exploded block diagrams illustrating the binder 1A according to the first exemplary embodiment before it is used.

The binder 1A of the first exemplary embodiment includes a spine portion 2A and ring portions 3A. The spine portion 2A is a narrow thin plate-shaped member and has a length to correspond to the length of paper 4 to be bound. In addition, the spine portion 2A has a plurality of engagement protrusions 5A arranged in a row at a predetermined interval in a longitudinal direction. The spine portion 2A is formed by a flexible and elastic deformable material such as a resin and the engagement protrusions 5A are incorporated thereto.

The engagement protrusions 5A, which are an example of the spine engagement portion, are arranged to correspond to the interval of the binding holes 4a formed on the sheets of paper 4. The transverse section of each engagement protrusion 5A is, for example, circular in shape so as to correspond to the shape of each corresponding engagement hole 6A. In addition, the engagement protrusions 5A have locking portions 5h for restraining the ring portions 3A from being detached.

In the locking portions 5h, as shown in FIG. 3A, the longitudinal section of the front end of each engagement protrusion 5A is, for example, triangular in shape. Some portion protrudes from a circumference of the front end of the corresponding engagement protrusion 5A so that each engagement portion 5h is configured to be hung on the corresponding engagement hole 6A of each ring portion 3A. In addition, in each engagement protrusion 5A, an introducing portion 5i with a taper shape is formed in the front end of the locking portion 5h.

In each engagement protrusion 5A, a gap between the lower end of the locking portion 5h and the spine portion 2A is provided as a part fitted into each ring portion 3A. In each engagement portion 5A, a height of a part to which the ring portion 3A is fitted is configured to be about twice as thick as the thickness of the ring portion 3A or to be substantially equal to or slightly larger than the thickness thereof.

As shown in FIG. 2A, each ring portion 3A is a thin plate-shaped member having a sufficient width to be inserted into the binding hole 4a. The plurality of engagement holes 6A are arranged in a row in the longitudinal direction of each ring portion 3A. Each ring portions 3A is formed of a flexible and elastic deformable material such as a resin, and the engagement protrusions 6A are formed therethrough.

The engagement holes 6A, which are an example of the ring engagement portion, are circular in shape, as shown in FIG. 3B, and are arranged, for example, at an identical interval. The hole diameter of each engagement hole 6A is configured to be smaller than that of each locking portion 5h.

### Use Example of Binder According To First Exemplary Embodiment

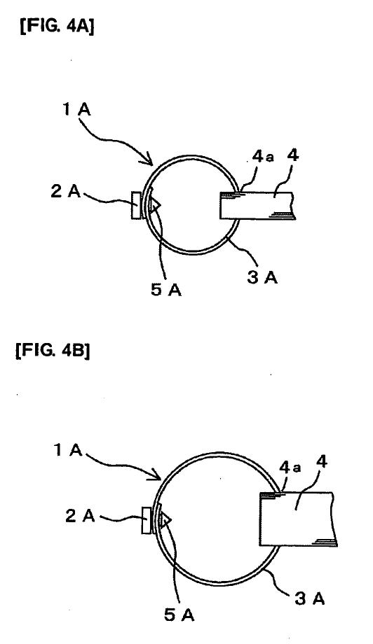

FIGS. 4A and 4B are exemplary block diagrams illustrating the binder according to the first exemplary embodiment when it is used. Next, the bind 1A according to the first exemplary embodiment will be described with reference to FIGS. 1 to 4B. FIG. 4A shows a case where the number of sheets of the paper 4 to be bound is small and FIG. 4B shows a case where the number of sheets of the paper 4 is large.

The spine portion 2A and the ring portions 3A are provided as components independent of each other. The ring portions 3A have, for example, a longitudinal shape and have an arbitrary length. The ring portions 3A are cut depending on the number of sheets of the paper 4 to be bound. For example, the ring portions 3A are cut short when the number of sheets of the paper 4 is small and are cut long when the number of sheets of the paper 4 is large.

The ring portions 3A cut in a desired length depending on the number of sheets of the paper 4 to be bound pass through the binding holes 4a of the sheets of paper 4. In addition, the engagement hole 6A(1) at one end of each ring portion 3A is fitted to the corresponding engagement protrusion 5A placed at a predetermined position of the spine portion 2A.

The engagement holes 6A of each ring portion 3A are fitted to the engagement protrusions 5A of the spine portion 2A. At this time, since the spine portion 2A and each ring portions 3A are formed of a flexible material, the engagement holes 6A of each ring portion 3A are pushed to introducing portions 5i of the engagement protrusions 5A of the spine portion 2A, and then the engagement holes 6A can be slowly widened in the shape of the taper of the introducing portions 5i of the engagement protrusions 5A. In this way, in each ring portion 3A, the circumferences of the engagement holes 6A are curved to be elastically deformed, and then fitted to the locking portions 5h of the engagement protrusions 5A. Subsequently, in each ring portion 3A, the shape of the circumferences of the engagement holes 6A is restored when the engagement holes 6A are fitted to the locking portions 5h of the engagement protrusions 5A.

As described above, the hole diameter of the engagement holes 6A of each ring portion 3A is smaller than that of the locking portions 5h of the engagement protrusions 5A. Accordingly, when the engagement holes 6A are fitted to the engagement protrusion 5A, the locking portions 5h of the engagement protrusions 5A restrain the engagement holes 6A from being detached. As a result, the ring portions 3A can be maintained in the spine portion 2A.

When the engagement hole 6A(1) at one end of each ring portion 3A is fitted to the engagement protrusion 5A of the spine portion 2A, the ring portion 3A is bent in the loop shape. At this time, the engagement hole 6A(2) at the other end of the ring portion 3A is fitted to the same engagement protrusion 5A to which the engagement hole 6A(1) at the one end thereof is fitted.

The height of a part of the engagement protrusion 5A to which the ring portion 3A is fitted is substantially equal to the thickness of two pieces of the ring portions 3A. Accordingly, when the engagement hole 6A(1) at the one end of the ring portion 3A is fitted to the engagement protrusion 5A of the ring portion 2A and the engagement hole 6A(2) at the other end of the same ring portion 3A is fitted to the same engagement protrusion 5A, the ring portion 3A is fitted to one engagement protrusion 5A so that both ends thereof are overlapped with each other.

Since the ring portions 3A are bent in the loop shape, the plural sheets of the paper 4 are bound so as to be turned. The plurality of binding holes 4a are punched on the sheets of paper 4. Accordingly, the ring portions 3A are inserted into all the binding holes 4a or arbitrary binding holes 4a selected if necessary and the engagement holes 6A, as described above, are fitted to the engagement protrusion 5A in the form of overlapping both ends of the ring portions 3A with each other. In this way, the loop-shaped ring portions 3A are configured.

In this case, since the engagement protrusions 5A of the spine portion 2A are arranged to correspond to the interval of the binding holes 4a of the sheets of paper 4, the ring portions 3A can be attached in correspondence with all the binding holes 4a and can be also attached in correspondence with the arbitrary binding holes 4a.

At this time, when the number of sheets of the paper 4 to be bound is small, the loop diameter of the ring portions 3A may be small as well. For this reason, as shown in FIG. 4A, the ring portions 3A with the small loop diameter can be formed by short cutting the longitudinal-shaped ring portions 3A. Alternatively, when the number of sheets of the paper 4 to be bound is large, it is required that the loop diameter of the ring portions 3A be large. For this reason, as shown in FIG. 4B, the ring portions 3A with the large loop diameter can be formed by long cutting the ring portions 3A.

In this way, since the ring portions 3A can be cut depending on the number of the sheets of paper 4 to be bound, it is possible to correspond to a difference in the number of sheets of the paper 4 to be bound with one type of the ring portions 3A. In addition, the spine portion 2A and the ring portions 3A are provided as components independent of each other. Accordingly, when the size of the sheets of paper 4 to be bound is equal, it is possible to correspond to the difference in the number of sheets of the paper 4 to be bound with one type of the spine portion 2A.

Moreover, when the spine portion 2A can be also cut depending on the size of the sheets of paper 4 to be bound, it is possible to correspond to plurality of types of different sizes (A4, B5, etc.) of the sheets of paper 4.

As a result, it is not required that plurality of types of components be prepared in correspondence with the difference in the number of sheets of the paper 4 to be bound. Moreover, a cost can be suppressed and an inventory management of consumption goods or the like can be easy.

In the binder 1A according to the first exemplary embodiment, the shapes of engagement protrusions 5A and the engagement holes 6A are the circle, but may be a different shape, for example, a square. In addition, the interval of the engagement holes 6A may be not equal. When plurality of types of the loop diameters are selected, the engagement holes may be arranged in consideration of, for example, a design and the like.

In the binder 1A according to the first exemplary embodiment, in correspondence with the sheets of paper 4 in which the binding holes 4a are punched in advance in the form of having two holes, three holes, or four holes, the spine portion 2A may be formed so that any one of the plurality of engagement protrusions 5A can correspond to the binding holes 4a of the sheets of paper 4 in which two holes, three holes, or four holes are punched in advance.

In the binder 1A, the spine portion 2A and the ring portions 3A are provided as the components independent of each other. Accordingly, by arranging the engagement protrusions 5A in the above-described way, one type of the spine portion 2A can be used so that the binder 1A can be provided even in the sheets of paper through which two holes, three holes, four holes, and so on are punched.

### Configuration Example Of Binder According To Second Exemplary Embodiment

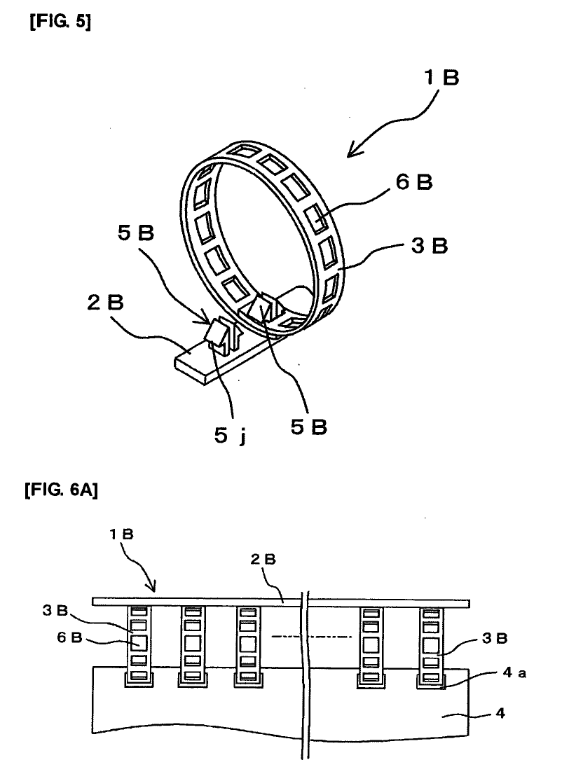

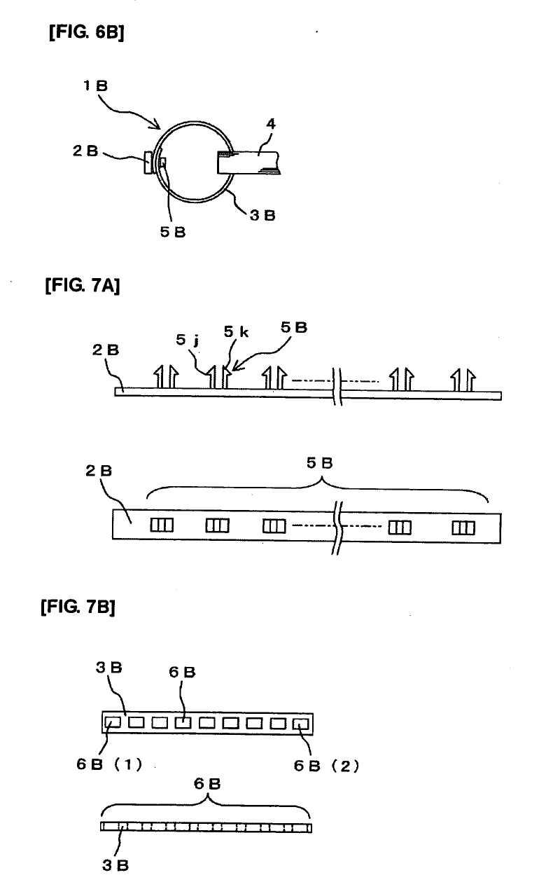

FIG. 5 is a perspective view illustrating an example of an assembled binder 1B according to a second exemplary embodiment. FIGS. 6A and 6B are front views illustrating an example of the binder 1B according to the second exemplary embodiment when the binder is used. FIGS. 7A and 7B are exploded block diagrams illustrating the binder 1B according to the second exemplary embodiment before the binder is used. In this case, the same reference numerals of the constituents of the binder 1A according to the first exemplary embodiment are given to those of the binder 1B according to the second exemplary embodiment.

In the binder 1B according to the second exemplary embodiment, a modified example of the engagement protrusion and the engagement hole is provided. The binder 1B includes a spine portion 2B in which engagement protrusions 5B are formed and ring portions 3B in which engagement holes 6B are formed.

The spine portion 2B is a thin plate-shaped member with a narrow width and has a length to correspond to the length of paper 4 to be bound. The engagement protrusions 5B are arranged in a row in a longitudinal direction of the spine portion 2B so as to correspond to the interval of the binding holes 4a of the sheets of paper 4. The spine portion 2B is formed of a flexible and elastic deformable material such as a resin and the engagement protrusions 5B are incorporated thereto.

Each engagement protrusion 5B is constituted by a pair of two members as shown in FIG. 7A. The transverse section of each engagement protrusion 5B is, for example, a square in shape with a gap formed between each engagement protrusion 5B constituted by so as to correspond to shape of the engagement holes 6B of the ring portions 3B. In addition, the engagement protrusions 5B have locking portions 5j for restrain the ring portions 3B from being detached.

In the locking portions 5j, the longitudinal section of the front end of each engagement protrusion 5B is, for example, triangular in shape. Some portion of the front end of each engagement protrusion 5B protrudes from the side surface so that each locking portion 5j is configured in the form of being hung on the engagement hole 6B of the ring portion 3B. In addition, in each engagement protrusion 5B, an introducing portion 5k with a taper shape is formed in the front end of the locking portion 5j.

In each engagement protrusion 5B, a gap between the lower end of the locking portion 5j and the spine portion 2B is provided as a part fitted into each ring portion 3B. In each engagement portion 5B, a height of a part to which the ring portion 3B is fitted is configured to be about twice as long as the thickness of the ring portion 3B or to be substantially equal to or slightly longer than the thickness thereof.

As shown in FIG. 6A, each ring portion 3B is a thin plate-shaped member having the width enough to be inserted into the binding hole 4a. The plurality of engagement holes 6B are lined in a row in the longitudinal direction of the ring portion 3B. The ring portions 3B are formed of a flexible and elastically deformable material such as a resin and the engagement holes 6B are formed through each ring portion 3B.

As shown in FIG. 7B, the engagement holes 6B are square in shape so as to be fitted to the engagement protrusion 5B and are arranged, for example, at an equivalent interval. The hole size of each engagement hole 6B is configured to be smaller than that of each locking portion 5j of the engagement protrusion 5B.

### Use Example of Binder According To Second Exemplary Embodiment

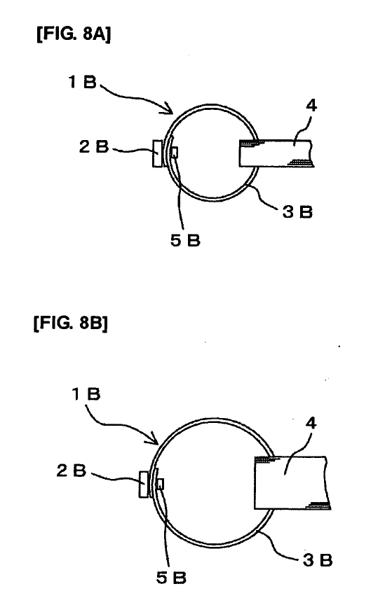

FIGS. 8A and 8B are exemplary block diagrams illustrating the binder 1B according to the second exemplary embodiment when it is used. Next, the bind 1B according to the second exemplary embodiment will be described with reference to FIGS. 5 to 8B. FIG. 8A shows a case where the number of sheets of the paper 4 to be bound is small and FIG. 8B shows a case where the number of sheets of the paper 4 is large.

The spine portion 2B and the ring portions 3B are provided independently each other. The ring portions 3B have, for example, a longitudinal shape and have an arbitrary length. The ring portions 3B are cut depending on the number of sheets of the paper 4 to be bound. For example, the ring portions 3B are cut short when the number of sheets of the paper 4 is small and are cut long when the number of sheets of the paper 4 is large.

The ring portions 3B cut in a desired length depending on the number of sheets of the paper 4 to be bound pass through the binding holes 4a of the sheets of paper 4. In addition, the engagement holes 6B(1) at one end of the ring portions 3B are fitted to the engagement protrusions 5B placed at a predetermined position of the spine portion 2B.

The spine portion 2B and the ring portions 3B are formed of a flexible and elastically deformable material. Accordingly, the engagement holes 6B of the ring portions 3B can be fitted to the engagement protrusion 5B of the spine portion 2B. At this time, when the engagement holes 6B of the ring portions 3B are pushed to introducing portions 5k of the engagement protrusions 5B of the spine portion 2B, the engagement holes 6B can be slowly widened in the shape of the taper of the introducing portions 5k of the engagement protrusions 5B. The engagement holes 6B of the ring portions 3B are pushed so that the engagement protrusions 5B are bent inward.

In this way, in the ring portions 3B, the engagement holes 6B are fitted to the locking portions 5j of the engagement protrusions 5B. In the spine portion 2B, the shape of the engagement protrusions 5B are restored when the engagement holes 6B of the ring portions 3B are fitted to the locking portions 5j of the engagement protrusions 5B. In the ring portions 3B, the circumferences of the engagement holes 6B are restored when the engagement holes 6B are fitted to the locking portions 5j of the engagement protrusions 5B.

As described above, the size of the engagement holes 6B of the ring portions 3B is smaller than that of the locking portions 5j of the engagement protrusions 5B. Accordingly, when the engagement holes 6B are fitted to the engagement protrusion 5B, the locking portions 5j of the engagement protrusions 5B restrain the engagement holes 6B from being detached. As a result, the ring portions 3B can be maintained in the spine portion 2B.

When the engagement hole 6B(1) at one end of each ring portion 3B is fitted to the engagement protrusion 5B of the spine portion 2B, the ring portion 3B is bent in the loop shape. At this time, the engagement hole 6B(2) at the other end of the ring portion 3B is fitted to the same engagement protrusion 5B to which the engagement hole 6B(1) at the one end thereof is fitted.

The height of a part of the engagement protrusion 5B to which the ring portion 3B is fitted is substantially equal to the thickness of two pieces of the ring portions 3B. Accordingly, the engagement hole 6B(1) at the one end of the ring portion 3B is fitted to the engagement protrusion 5B of the ring portion 2B and the engagement hole 6B(2) at the other end of the same ring portion 3B is fitted to the same engagement protrusion 5B, the ring portion 3B is fitted to one engagement protrusion 5B so that both ends thereof are overlapped with each other.

The ring portions 3B are bent in the loop shape, thereby binding the plural sheets of the paper 4 so as to be turned. The plurality of binding holes 4a are punched on the sheets of paper 4. Accordingly, the ring portions 3B are inserted into all the binding holes 4a or arbitrary binding holes 4a selected if necessary and the engagement holes 6B, as described above, are fitted to the engagement protrusion 5B in the form of overlapping both ends of the ring portions 3B with each other. In this way, the loop-shaped ring portions 3B are configured.

In this case, since the engagement protrusions 5B of the spine portion 2B are arranged to correspond to the interval of the binding holes 4a of the sheets of paper 4, the ring portions 3B can be attached in correspondence with all the binding holes 4a and can be also attached in correspondence with the arbitrary binding holes 4a.

At this time, when the number of sheets of the paper 4 to be bound is small, the loop diameter of the ring portions 3B may be small as well. For this reason, as shown in FIG. 8A, the ring portions 3B with the small loop diameter can be formed by short cutting the longitudinal-shaped ring portions 3B. Alternatively, when the number of sheets of the paper 4 to be bound is large, it is required that the loop diameter of the ring portions 3B be large. For this reason, as shown in FIG. 8B, the ring portions 3B with the large loop diameter can be formed by long cutting the ring portions 3B.

In this way, since the ring portions 3B can be cut depending on the number of the sheets of paper 4 to be bound in the same way in the binder according to the first exemplary embodiment, it is possible to correspond to a difference in the number of sheets of the paper 4 to be bound with one type of the ring portions 3B. In addition, the spine portion 2B and the ring portions 3B are provided as components independent of each other. Accordingly, when the size of the sheets of paper 4 to be bound is equal, it is possible to correspond to the difference in the number of sheets of the paper 4 to be bound with one type of the spine portion 2B.

Moreover, when the spine portion 2B can be also cut depending on the size of the sheets of paper 4 to be bound, it is possible to correspond to plurality of types of different sizes (A4, B5, etc.) of the sheets of paper 4.

As a result, it is not required that plurality of types of components be prepared in correspondence with the difference in the number of sheets of the paper 4 to be bound. Moreover, a cost can be suppressed and an inventory management of consumption goods or the like can be easy.

### Configuration Example Of Binder According To Third Exemplary Embodiment

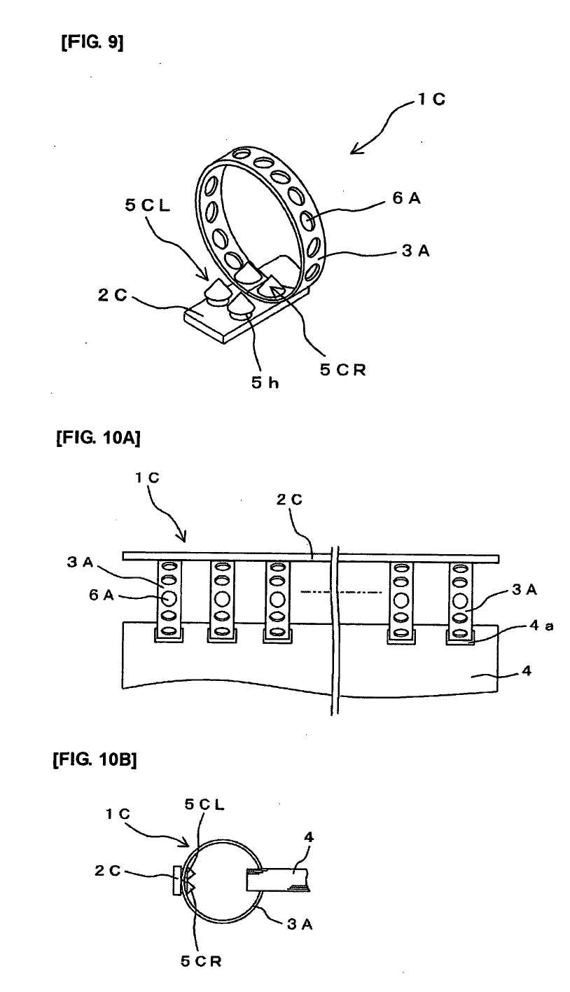

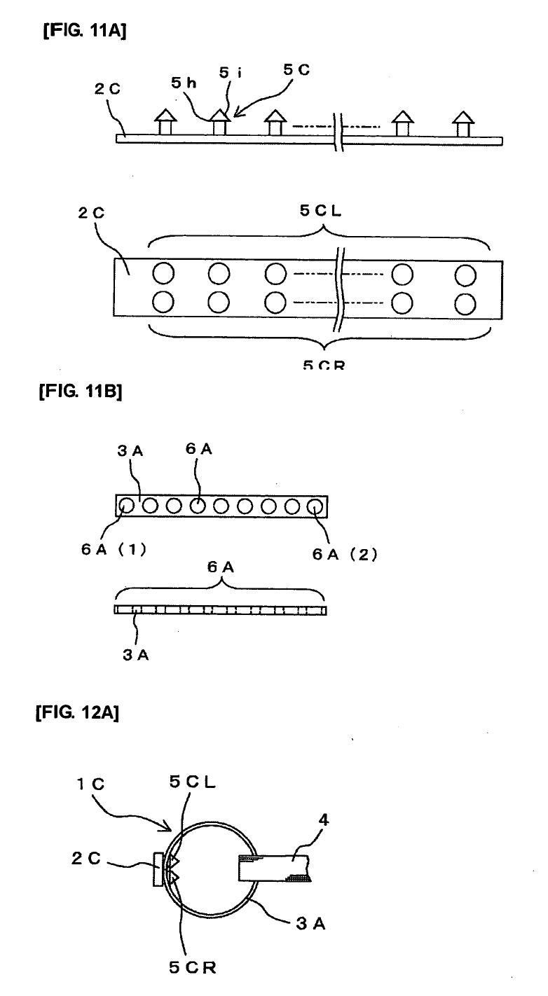

FIG. 9 is a perspective view illustrating an example of an assembled binder 1C according to a third exemplary embodiment. FIGS. 10A and 10B are top views illustrating an example of a binder 1C according to the third exemplary embodiment when the binder is used. FIGS. 11A and 11B are exploded block diagrams illustrating the binder 1C according to the third exemplary embodiment before the binder is used. In this case, the same reference numerals of the constituents of the binder 1A according to the first exemplary embodiment are given to those of the binder 1C according to the third exemplary embodiment.

The binder 1C according to the third exemplary embodiment includes a spine portion 2C in which engagement protrusions to which the ring portions 3A are fitted are arranged in two rows. That is, the spine portion 2C includes a first row of engagement protrusions 5CL arranged in a row in a longitudinal direction at a interval to correspond to the binding holes 4a of a paper 4 and a second row of engagement protrusions 5CR arranged in parallel with the first row of the engagement protrusions 5CL at the same interval as the first row of the engagement protrusions 5CL.

The shape of the first row of the engagement protrusions 5CL and the second row of the engagement protrusions 5CR may be the same as that of the engagement protrusions 5A described in the binder 1A according to the first exemplary embodiment. In this case, the ring portions 3A may be the same as the ring portions of the binder 1A according to the first exemplary embodiment.

However, the height of a part to which the engagement protrusions 5CL and 5CR may be fitted is the substantial same as the thickness of the ring portions 3A.

The shape of the engagement protrusions 5CL and 5CR may be the same as that the engagement protrusions 5B described in the binder 1B according to the second exemplary embodiment. Further, the shape of the ring portions may be the same as that of the ring portions 3B according to the second exemplary embodiment.

### Use Example of Binder According To Third Exemplary Embodiment

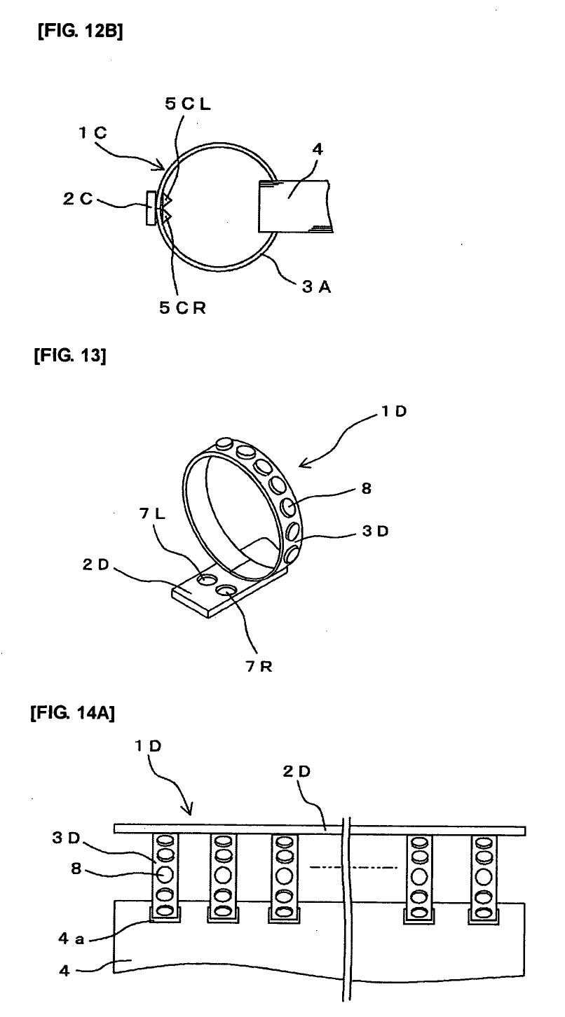

FIGS. 12A and 12B are exemplary block diagrams illustrating the binder 1C according to the second exemplary embodiment. Next, the bind 1C according to the third exemplary embodiment will be described with reference to FIGS. 9 to 12B. FIG. 12A shows a case where the number of sheets of a paper 4 to be bound is small and FIG. 12B shows a case where the number of sheets of the paper 4 is large.

The spine portion 2C and the ring portions 3A are provided independently each other. The ring portions 3A have, for example, a longitudinal shape and have an arbitrary length. The ring portions 3A are cut depending on the number of sheets of the paper 4 to be bound. For example, the ring portions 3A are cut short when the number of sheets of the paper 4 is small and are cut long when the number of sheets of the paper 4 is large.

The ring portions 3A cut in a desired length depending on the sheets of paper 4 to be bound pass through the binding holes 4a of the sheets of paper 4. In addition, the engagement holes 6A(1) at one end of the ring portions 3A are inserted to the first row of the engagement protrusions 5CL placed at a predetermined position of the spine portion 2C.

When the engagement holes 6A of the ring portions 3A are fitted to the engagement protrusion 5CL of the spine portion 2C, the engagement holes 6A of the ring portions 3A are slowly widened in the shape of the taper of the introducing portions 5i of the engagement protrusions 5CL to be fitted to the locking portions 5h of the engagement protrusions 5CL in the same way in the use example of the binder 1A according to the first exemplary embodiment. In the ring portions 3A, the circumferences of the engagement holes 6A are restored when the engagement holes 6A are fitted to the locking portions 5h of the engagement protrusions 5CL.

As described above, the hole diameter of the engagement holes 6A of the ring portions 3A is smaller than that of the locking portions 5h of the engagement protrusions 5CL. Accordingly, when the engagement holes 6A are fitted to the engagement protrusion 5CL, the locking portions 5h of the engagement protrusions 5CL restrain the engagement holes 6A from being detached. As a result, the ring portions 3A can be maintained in the spine portion 2C.

When the engagement holes 6A(1) at one end of the ring portions 3A are fitted to the first row of the engagement protrusions 5CL of the spine portion 2C, the ring portions 3A are bent in the loop shape. Accordingly, the engagement holes 6A(2) at the other end of the ring portions 3A are fitted to the second row of the engagement protrusions 5CR adjacent to the first engagement protrusions 5CL to which the engagement holes 6A(1) at the one end thereof are fitted. The way how the engagement holes 6A(2) are fitted to the engagement protrusions 5CR is the same as that how the engagement holes 6A(1) are fitted to the engagement protrusions 5CL.

Then, the ring portions 3A are maintained in the spine portion 2C so that the end surfaces at both ends are opposed to each other without an overlap of the ends. Thus, the ring portions 3A are bent in the loop shape, thereby binding the plural sheets of the paper 4 so as to be turned.

The plurality of binding holes 4a are punched on the sheets of paper 4. Accordingly, the ring portions 3A are inserted into all the binding holes 4a or arbitrary binding holes 4a selected if necessary and the engagement holes 6A(1) at the one end of the ring portions 3A, as described above, are fitted to the first row of the engagement protrusion 5CL and the engagement holes 6A(2) at the other end of the ring portions 3A are fitted to the second row of the engagement protrusions 5CR.

In this way, the loop-shaped ring portions 3A are configured.

In this case, since the engagement protrusions 5CL and 5CR of the spine portion 2C are arranged to correspond to the interval of the binding holes 4a of the sheets of paper 4, the ring portions 3A can be attached in correspondence with all the binding holes 4a and can be also attached in correspondence with the arbitrary binding holes 4a.

At this time, when the number of sheets of the paper 4 to be bound is small, the loop diameter of the ring portions 3A may be small as well. For this reason, as shown in FIG. 12A, the ring portions 3A with the small loop diameter can be formed by short cutting the longitudinal-shaped ring portions 3A. Alternatively, when the number of sheets of the paper 4 to bound is large, it is required that the loop diameter of the ring portions 3A be large. For this reason, as shown in FIG. 12B, the ring portions 3A with the large loop diameter can be formed by long cutting the ring portions 3A.

In this way, since the ring portions 3A can be cut depending on the number of the sheets of paper 4 to be bound in the same way in the binder according to the first exemplary embodiment, it is possible to correspond to a difference in the number of sheets of the paper 4 to be bound with one type of the ring portions 3A. In addition, the spine portion 2C and the ring portions 3A are provided as components independent of each other. Accordingly, when the size of the paper 4 to be bound is equal, it is possible to correspond to the difference in the number of sheets of the paper 4 to be bound with one type of the spine portion 2C.

Moreover, when the spine portion 2C can be also cut depending on the size of the sheets of paper 4 to bound, it is possible to correspond to plurality of types of different sizes (A4, B5, etc.) of the sheets of paper 4.

Since the ring portions 3A can be bent in the loop shape so as not to overlap the mutual ends of the ring portions 3A by arranging the engagement protrusions 5C in two rows on the spine portion 2C, it is difficult for the loop shape to be deformed. In particular, even when the loop diameter is small, as shown in FIG. 12A, it is difficult to be deformed. As a result, the exterior appearance can be improved and it is easy to turn sheets of paper.

In the binder 1C according to the third exemplary embodiment, the shape of the engagement protrusions 5CL and 5CR and the engagement holes 6A are the circle, but may be other shapes such as a square.

### Configuration Example Of Binder According To Fourth Exemplary Embodiment

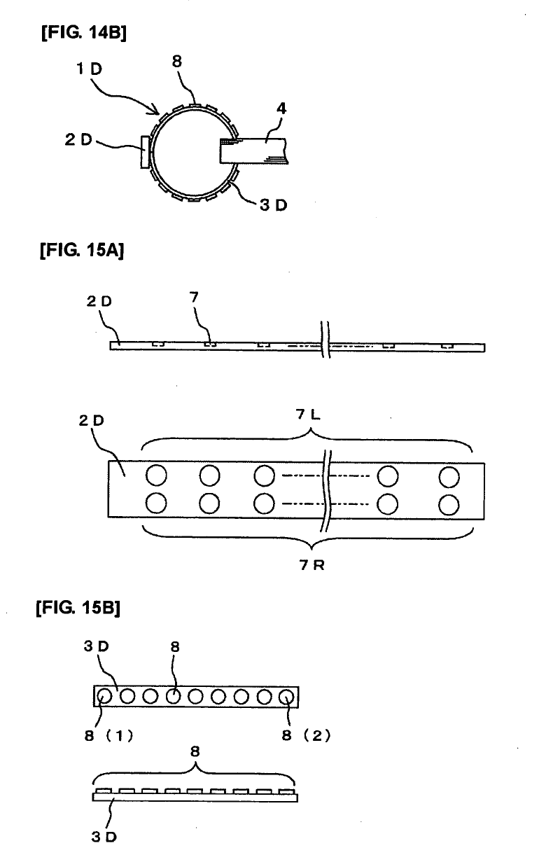

FIG. 13 is a perspective view illustrating an example of an assembled binder 1D according to a fourth exemplary embodiment. FIGS. 14A and 14B are top views illustrating an example of the binder 1D according to the fourth exemplary embodiment when it is used. FIGS. 15A and 15B are exploded block diagrams illustrating the binder 1D according to the fourth exemplary embodiment before the binder is used.

The binder 1D according to the fourth exemplary embodiment includes a spine portion 2D and the ring portions 3D. The spine portion 2D is a thin plate-shaped member with a narrow width and has a length depending on the length of a paper 4 to be bound. In addition, the binder 1D includes a first row of engagement holes 7L arranged in a row in a longitudinal direction at a interval to correspond to the binding holes 4a of the sheets of paper 4 and a second row of engagement holes 7R arranged in parallel with the first row of the engagement holes 7L at the same interval as the first row of the engagement holes 7L. The spine portion 2D is formed of a flexible and elastically deformable material, for example, a resin. In addition, the engagement holes 7L and 7R are formed in a concave shape.

The engagement holes 7L and 7R are examples of the spine engagement portions and the transverse section thereof has, for example, a circular shape to correspond to the shape of the engagement protrusion 8 formed in the ring portions 3D.

As shown in FIG. 14A, each ring portion 3D is a thin plate-shaped member having a sufficient width to be inserted into the corresponding binding hole 4a of the sheets of paper 4. Plurality of engagement protrusions 8 are lined in a row in a longitudinal direction of the ring portions 3D. The ring portions 3D are formed of a flexible and elastically deformable material such as a resin and the engagement protrusions 8 are incorporated thereinto.

The engagement protrusions 8 that are examples of the ring engagement portion are cylindrical in shape so as to be inserted into the engagement holes 7L and 7R of the spine portion 2D, as shown in FIG. 15B, and the engagement protrusions 8 are arranged at an equivalent interval. The diameter of the engagement protrusions 8 is slightly larger than that of the engagement holes 7L and 7R. The engagement protrusions 8 are configured to be press-inserted into the engagement holes 7L and 7R.

### Use Example of Binder According To Fourth Exemplary Embodiment

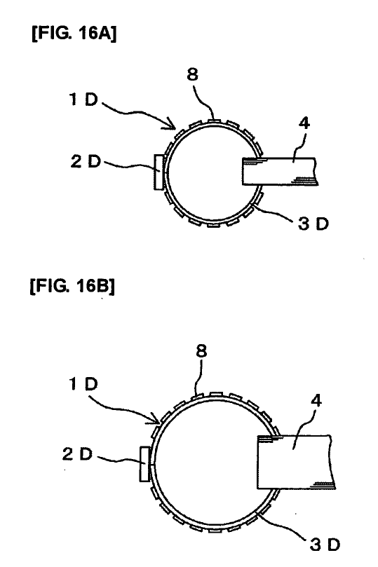

FIGS. 16A and 16B are exemplary block diagrams illustrating the binder 1D according to the fourth exemplary embodiment. Next, the bind 1D according to the fourth exemplary embodiment will be described with reference to FIGS. 13 to 16B. FIG. 16A shows a case where the number of sheets of a paper 4 to be bound is small and FIG. 16B shows a case where the number of sheets of the paper 4 is large.

The spine portion 2D and the ring portions 3D are provided independently each other. The ring portions 3D have, for example, a longitudinal shape and have an arbitrary length. The ring portions 3D are cut depending on the number of sheets of the paper 4 to be bound. For example, the ring portions 3D are cut short when the number of sheets of the paper 4 is small and are cut long when the number of sheets of the paper 4 is large.

The ring portions 3D cut in a desired length depending on the number of the sheets of paper 4 to be bound pass through the binding holes 4a of the sheets of paper 4. In addition, the engagement holes 8(1) at one end of the ring portions 3D are press-inserted into a first row of the engagement holes 7L placed at a predetermined position of the spine portion 2D.

When the engagement protrusions 8 of the ring portions 3D are press-inserted into the engagement holes 7L of the spine portion 2D, the one end of the ring portions 3D are maintained in the spine portion 2D.

When the engagement protrusions 8(1) at the one ends of the ring portions 3D are press-inserted into the first row of the engagement holes 7L of the spine portions 2D, the ring portions 3D are bent in the loop shape. At this time, the engagement protrusions 8(2) at the other ends of the ring portions 3D are press-inserted into the second row of the engagement holes 7R adjacent to the first row of the engagement holes 7L into which the engagement protrusions 8(1) at the one end thereof are inserted.

In this way, the ring portions 3D are maintained in the spine portion 2D so that the end surfaces of the ends are opposed to each other without an overlap of the ends. Thus, the ring portions 3D are bent in the loop shape, thereby binding the plural sheets of the paper 4 so as to be turned.

The plurality of binding holes 4a are punched on the sheets of paper 4. Accordingly, the ring portions 3D are inserted into all the binding holes 4a or arbitrary binding holes 4a selected if necessary and the engagement holes 8(1) at one ends of the ring portions 3D, as described above, are fitted to the first row of the engagement protrusion 7L and the engagement holes 8(2) at the other ends of the ring portions 3D are fitted to the second row of the engagement protrusions 7R. In this way, the loop-shaped ring portions 3D are configured.

In this case, since the engagement holes 7L and 7R of the spine portion 2D are arranged to correspond to the interval of the binding holes 4a of the sheets of paper 4, the ring portions 3D can be attached in correspondence with all the binding holes 4a and can be also attached in correspondence with the arbitrary binding holes 4a.

At this time, when the number of sheets of the paper 4 to be bound is small, the loop diameter of the ring portions 3D may be small as well. For this reason, as shown in FIG. 16A, the ring portions 3D with the small loop diameter can be formed by short cutting the longitudinal-shaped ring portions 3D. Alternatively, when the number of sheets of the paper 4 to be bound is large, it is required that the loop diameter of the ring portions 3D be large. For this reason, as shown in FIG. 16B, the ring portions 3D with the large loop diameter can be formed by long cutting the ring portions 3D.

In this way, since the ring portions 3D can be cut depending on the number of sheets of the paper 4 to be bound in the same way in the binder according to the first exemplary embodiment, it is possible to correspond to a difference in the number of sheets of the paper 4 to be bound with one type of the ring portions 3D. In addition, the spine portion 2D and the ring portions 3D are provided as components independent of each other. Accordingly, when the size of the sheets of paper 4 to be bound is equal, it is possible to correspond to the difference in the number of sheets of the paper 4 to be bound with one type of the spine portion 2D.

Moreover, when the spine portion 2D can be also cut depending on the size of the sheets of paper 4 to be bound, it is possible to correspond to plurality of types of different sizes (A4, B5, etc.) of the sheets of paper 4.

Since the ring portions 3D can be bent in the loop shape so as not to overlap the mutual ends of the ring portions 3D by arranging the engagement holes 7 in two rows on the spine portion 2D, it is difficult for the loop shape to be deformed. In particular, even when the loop diameter is small, as shown in FIG. 16A, it is difficult to be deformed. As a result, the exterior appearance can be improved and it is easy to turn sheets of paper.

In the binder 1D according to the fourth exemplary embodiment, the shape of the engagement holes 7L and 7R and the engagement protrusions 8 are the circle, but may be other shapes such as a square.

### Configuration Example Of Binder According To Fifth Exemplary Embodiment

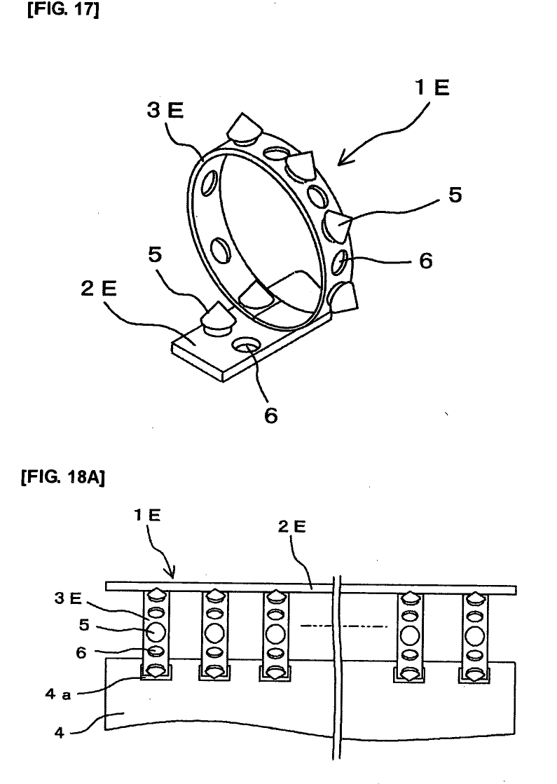

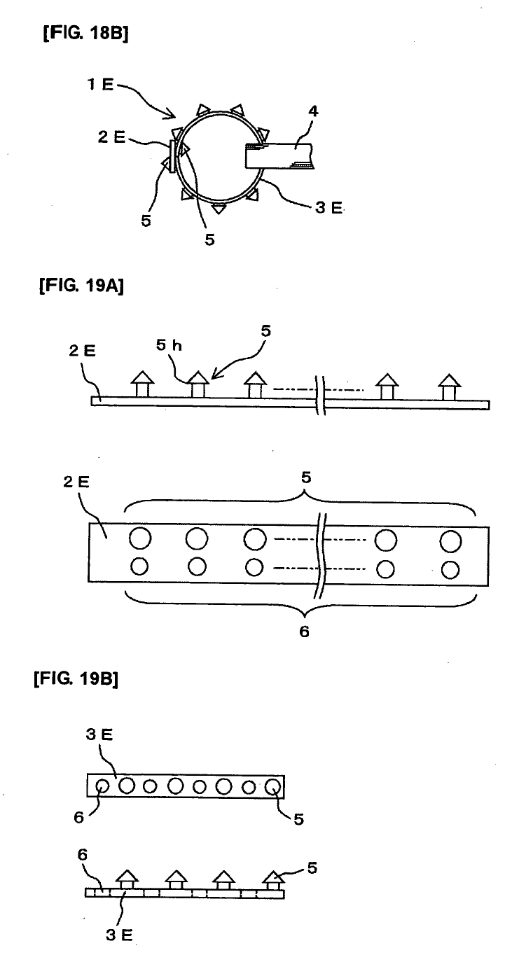

FIG. 17 is a perspective view illustrating an example of an assembled binder 1E according to a fifth exemplary embodiment. FIGS. 18A and 18B are top views illustrating an example of the binder 1E according to the fifth exemplary embodiment when it is used. FIGS. 19A and 19B are exploded block diagrams illustrating the binder 1E according to the fifth exemplary embodiment before the binder is used. In this case, the same reference numerals of the constituents of the binder 1A according to the first exemplary embodiment are given to those of the binder 1E according to the fifth exemplary embodiment.

The binder 1E according to the fifth exemplary embodiment includes a spine portion 2E and the ring portions 3E. As shown in FIG. 19A, the spine portion 2E is a thin plate-shaped member with a narrow width and has a length depending on the length of a paper 4 to be bound. In addition, the spine portion 2E includes a first row of engagement protrusions 5 arranged in a row in a longitudinal direction at an interval to correspond to the binding holes 4a of the sheets of paper 4 and engagement holes 6 arranged in parallel with the engagement protrusions 5 at the same interval as the engagement protrusions 5. The spine portion 2E is formed of a flexible and elastically deformable material, for example, a resin. In addition, the engagement protrusions 5 are incorporated thereto.

In this case, the shape of the engagement protrusions formed in the spine portion 2E may be the same as that of the engagement protrusions 5A formed in the spine portion 2A described in the binder 1A according to the first exemplary embodiment. However, the height of a part to which the ring portion 3E of each engagement protrusion 5 is fitted may be a substantial thickness of each ring portion 3E.

The shape of the engagement holes 6 formed in the spine portion 2E may be the same as that of the engagement holes 6A formed in the ring portions 3A described in the binder 1A according to the first exemplary embodiment.

As shown in FIGS. 18A and 19B, each ring portion 3E is a thin plate-shaped member having a sufficient width to be inserted into the corresponding binding hole 4a of the sheets of paper 4. Plurality of engagement protrusions 5 and the engagement holes 6 are formed in a row a longitudinal direction of the ring portions 3E, for example, alternately at an equivalent interval. The ring portions 3E are formed of a flexible and elastically deformable material such as a resin and the engagement protrusions 5 are incorporated.

In this case, the shape of the engagement holes 6 formed in the ring portion 3E may be the same as that of the engagement holes 6A formed in the ring portions 3A described in the binder 1A according to the first exemplary embodiment.

The shape of the engagement protrusions 5 formed in the ring portions 3E may be the same as that of the engagement protrusions 5A formed in the spine portion 2A described in the binder 1A according to the first exemplary embodiment.

### Use Example of Binder According To Fifth Exemplary Embodiment

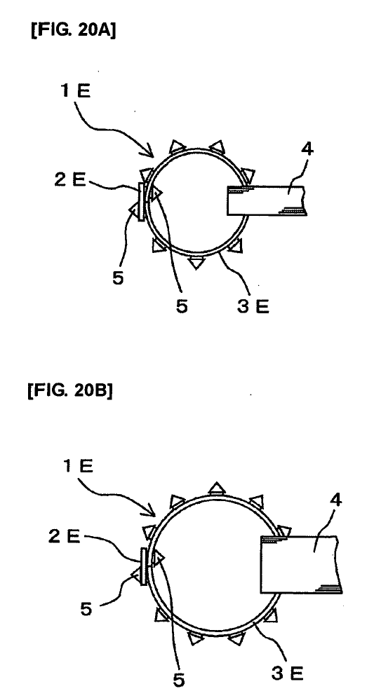

FIGS. 20A and 20B are exemplary block diagrams illustrating the binder 1E according to the fifth exemplary embodiment. Next, the bind 1E according to the fifth exemplary embodiment will be described with reference to FIGS. 17 to 20B. In this case, FIG. 20A shows a case where the number of sheets of a paper 4 to be bound is small and FIG. 20B shows a case where the number of sheets of the paper 4 is large.

First, the spine portion 2E and the ring portions 3E are provided independently each other. The ring portions 3E have, for example, a longitudinal shape and have an arbitrary length. The ring portions 3E are cut depending on the number of sheets of the paper 4 to be bound. For example, the ring portions 3E are cut short when the number of sheets of the paper 4 is small and are cut long when the number of sheets of the paper 4 is large.

In this case, when each ring portion 3E is cut, the engagement hole 6 is placed at one end thereof, for example, and the engagement protrusion 5 is placed at the other end thereof.

Each the ring portion 3E that is cut in a desired length depending on the number of sheets of the paper 4 to be bound passes through the corresponding binding hole 4a of the sheets of paper 4. In addition, in the example of the one end of each ring portion 3E, the engagement hole 6 are fitted to the engagement protrusion 5 placed in a predetermined position of the spine portion 2E.

When the engagement holes 6 of the ring portions 3E are fitted to the engagement protrusions 5 of the spine portion 2E, the engagement holes 6 of the ring portions 3E are fitted to the locking portion 5h of the engagement protrusions 5 so as to maintain the one ends of the ring portions 3E in the spine portion 2E like the use example of the binder 1A according to the first exemplary embodiment.

When the engagement holes 6 at the one end of the ring portions 3E are fitted to the engagement protrusions 5 of the spine portion 2E, the ring portions 3E are bent in the loop shape. At this time, the engagement protrusions 5 at the other ends of the ring portions 3E are inserted to the engagement holes 6 adjacent to the engagement protrusions 5 to which the engagement holes 6 at the one end are fitted. The way how the engagement protrusions 5 of the ring portions 3E are inserted into the engagement holes 6 of the spine portion 3E is the same as that how the engagement holes 6 of the ring portions 3E are fitted to the engagement protrusions 5 of the spine portion 2E.

In this way, the ring portions 3E are maintained in the spine portion 2E so that the end surfaces of the ends are opposed to each other without an overlap of the ends. Thus, the ring portions 3E are bent in the loop shape, thereby binding the plural sheets of the paper 4 so as to be turned.

The plurality of binding holes 4a are punched on the sheets of paper 4. Accordingly, the ring portions 3E are inserted into all the binding holes 4a or arbitrary binding holes 4a selected if necessary and the engagement holes 6 at the one end of the ring portions 3E, as described above, are fitted to the engagement protrusion 5 and the engagement protrusions 5 of the spine portion 2E at the other end thereof are inserted to the engagement holes 6 of the spine portion 2E. In this way, the loop-shaped ring portions 3E are configured.

In this case, since the engagement protrusions 5 and the engagement holes 6 of the spine portion 2E are arranged to correspond to the interval of the binding holes 4a of the sheets of paper 4, the ring portions 3E can be attached in correspondence with all the binding holes 4a and can be also attached in correspondence with the arbitrary binding holes 4a.

At this time, when the number of sheets of the paper 4 to be bound is small, the loop diameter of the ring portions 3E may be small as well. For this reason, as shown in FIG. 20A, the ring portions 3E with the small loop diameter can be formed by short cutting the longitudinal-shaped ring portions 3E. Alternatively, when the number of sheets of the paper 4 to be bound is large, it is required that the loop diameter of the ring portions 3E be large. For this reason, as shown in FIG. 20B, the ring portions 3E with the large loop diameter can be formed by long cutting the ring portions 3E.

In this way, since the ring portions 3E can be cut depending on the number of the sheets of paper 4 to be bound in the same way in the binder according to the first exemplary embodiment, it is possible to correspond to a difference in the number of sheets of the paper 4 to be bound with one type of the ring portions 3E. In addition, the spine portion 2E and the ring portions 3E are provided as components independent of each other. Accordingly, when the size of the sheets of paper 4 to be bound is equal, it is possible to correspond to the difference in the number of sheets of the paper 4 to be bound with one type of the spine portion 2E.

Moreover, when the spine portion 2E can be also cut depending on the size of the sheets of paper 4 to be bound, it is possible to correspond to plurality of types of different sizes (A4, B5, etc.) of the sheets of paper 4.

Since the ring portions 3E can be bent in the loop shape so as not to overlap the mutual ends of the ring portions 3E by arranging the engagement protrusions 5 and the engagement holes 6 on the spine portion 2E, it is difficult for the loop shape to be deformed. In particular, even when the loop diameter is small, as shown in FIG. 20A, it is difficult to be deformed. As a result, the exterior appearance can be improved and it is easy to turn sheets of paper.

In the binder 1E according to the fifth exemplary embodiment, the shape of the engagement protrusions 5 and the engagement holes 6 are the circle, but may be other shapes such as a square.

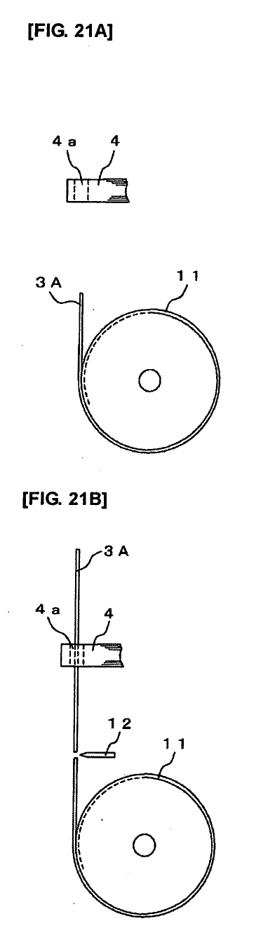

FIGS. 21A to 21C are explanatory diagrams illustrating an example of a process of manufacturing the binder according to the invention.

In addition, the manifesting process will be described using an example the binder 1A according to the first exemplary embodiment.

First, as shown in FIG. 21A, each ring portion 3A is connected in a longitudinal shape. For example, the ring portion 3A is configured as a ring portion supply body 11 in a rolling shape. The paper 4 is set so that the predetermined number of sheets thereof is piled so as to correspond to the direction of the binding holes 4a.

Each ring portion 3A that is unrolled from the ring portion supply body 11 is inserted into the corresponding binding hole 4a of the sheets of paper 4. As shown in FIG. 21B, the ring portion 3A is cut in a length depending on the number of sheets of the paper 4 or the like.

Subsequently, the ring portion 3A that is cut in a predetermined length is bent in the loop shape. The engagement hole 6A(1) at the one end and the engagement hole 6A(2) at the other end shown in FIG. 3B are overlapped with each other to be fitted to the engagement protrusion 5A shown in FIG. 21C.

In this way, the ring portions 3A with the loop diameter depending on the number of sheets of the paper 4 are attached to the spine portion 2A. Thus, the plural sheets of the paper 4 are bound so that a document can be formed.

### Configuration Example Of Binder According To Sixth Exemplary Embodiment

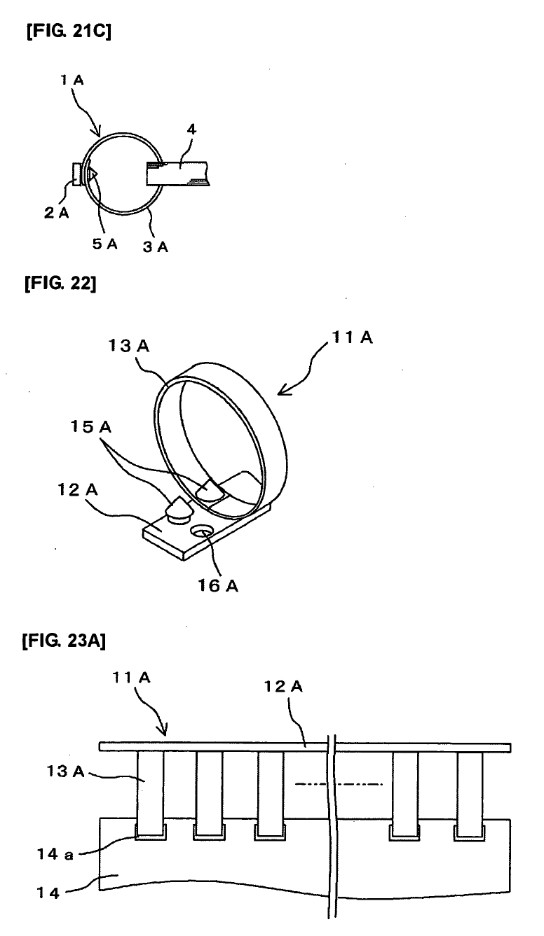

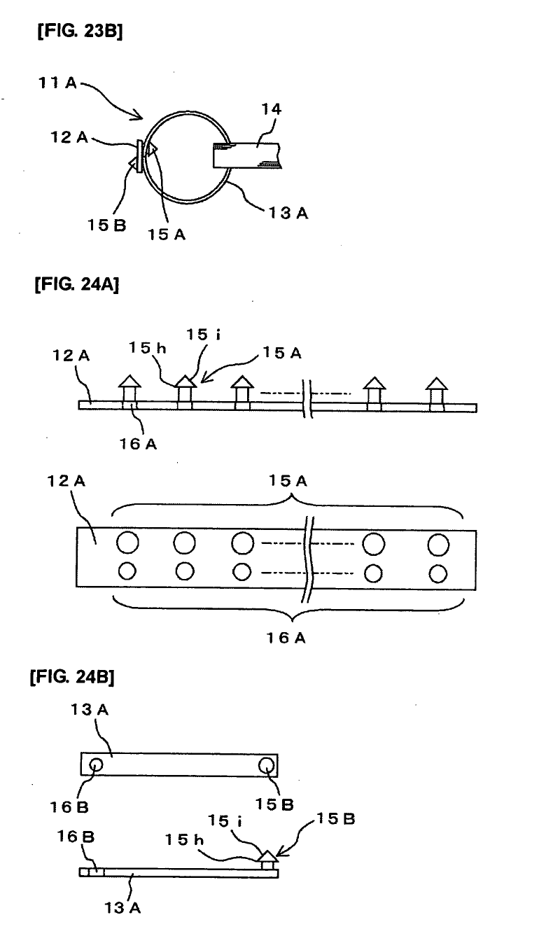

FIG. 22 is a perspective view illustrating an example of an assembled binder 11A according to a sixth exemplary embodiment. FIGS. 23A and 23B are top views illustrating an example of the binder 11A according to the sixth exemplary embodiment when it is used. FIGS. 24A and 24B are exploded block diagrams illustrating the binder 11A according to the sixth exemplary embodiment before the binder is used.

The binder 11A according to the sixth exemplary embodiment includes a spine portion 12A and ring portions 13A. The spine portion 12A is a thin plate-shaped member with a narrow width and has a length depending on the length of a paper 4 to be bound. In addition, the spine portion 12A includes plurality of engagement protrusions 15A arranged in a row in a longitudinal direction at a predetermined interval and plurality of engagement holes 16A arranged in parallel with the engagement protrusions 15A. The spine portion 12A is formed of a flexible and elastically deformable material, for example, a resin. In addition, the engagement protrusions 15A are incorporated thereinto and the engagement holes 16A are formed therethrough.

The engagement protrusions 15A, which are an example of the spine engagement portion, arranged to correspond to the interval of the binding holes 4a formed on the sheets of paper 4. The transverse section of each engagement protrusion 5A is, for example, circular in shape so as to correspond to the shape of the corresponding engagement hole 16B formed in the ring portion 13A. In addition, the engagement protrusions 15A have locking portions 15h for restrain the ring portions 3A from being detached.

In the locking portions 15h, as shown in FIG. 24A, the longitudinal section of the front end of each engagement protrusion 15A is, for example, triangular in shape. Some portion protrudes from a circumference of the front end of the corresponding engagement protrusion 15A so that each engagement portion 15h is configured to be hung on the engagement hole 16A of the ring portion 13A. In addition, in each engagement protrusion 15A, an introducing portion 15i with a taper shape is formed at the front end of the locking portion 15h.

In each engagement protrusion 15A, a gap between the lower end of the locking portion 15h and the spine portion 12A is provided as a part inserted into each ring portion 13A. In each engagement portion 15A, a height of the part into which the ring portion 13A is fitted is configured to be substantially equal to or slightly larger than the thickness of the ring portion 13A.

The engagement holes 16A, which are an example of the spine engagement portion, are circular in shape and the engagement protrusions 15B formed in the ring portions 13A are inserted thereto.

As shown in FIG. 23A, each ring portions 13A is a thin plate-shaped member having a sufficient width to be inserted into the binding hole 14a. As shown in FIG. 24B, the protrusion holes 16B are formed, for example, at one end in a longitudinal direction and the engagement protrusions 15B are formed at the other end. The ring portions 13A are formed of a flexible and elastic deformable material such as a resin, and the engagement protrusions 15A are incorporated thereinto and the engagement holes 16B are formed therethrough.

The engagement protrusions 15B, which are an example of the ring engagement portion, have the same configuration as the engagement protrusions 15A of the spine portion 12A as shown in FIG. 24B. Accordingly, the locking portions 15h in which introducing portions 15i are formed are provided at the front end. In this case, the hole diameter of the engagement holes 16A of the spine portion 12A to which the engagement protrusions 15B are fitted is configured to be smaller than the diameter of the locking portions 15h of the engagement protrusions 15B.

The engagement holes 16B, which are an example of the ring engagement portion, are circular in shape and the engagement protrusions 15A of the spine portion 12A are inserted thereinto as shown in FIG. 24B. The hole diameter of each engagement hole 16B is configured to be smaller than that of the locking portion 15h of the engagement protrusion 15A.

### Use Example of Binder According To Sixth Exemplary Embodiment

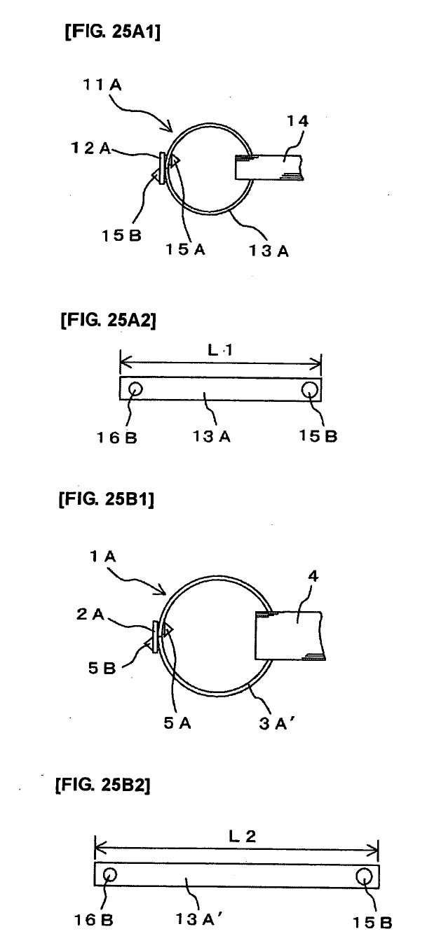

FIGS. 25A1 to 25B2 are exemplary block diagrams illustrating the binder 11A according to the sixth exemplary embodiment. Next, the bind 11A according to the sixth exemplary embodiment will be described with reference to FIGS. 22 to 25B2. FIGS. 25A1 and 25A2 show a case where the number of sheets of a paper 14 to be bound is small and FIGS. 25B1 and 25B2 show a case where the number of sheets of the paper 14 is large.

First, the spine portion 12A and the ring portions 13A are provided independently each other. The plurality of types of the ring portions 13A having different lengths depending on the number of sheets of the paper 14 to be bound are prepared. When the number of sheets of the paper 14 to be bound is small, as shown in FIG. 25A1, the ring portions 13A having the short length L1 are used as shown in FIG. 25A2. Alternatively, when the number of sheets of the paper 14 to be bound is large, as shown in FIG. 25B1, the ring portions 13A′ having the long length L2 are used as shown in FIG. 25B2.

For example, each the ring portion 13A passes through the corresponding binding hole 14a of the sheets of paper 14. In addition, the engagement hole 16B at the one end of each ring portion 13A are fitted to the engagement protrusion 15A placed in a predetermined position of the spine portion 12A.

The spine portion 12A and the ring portions 13A are formed of a flexible material. Accordingly, the engagement holes 16B of the ring portions 13A can be fitted to the engagement protrusions 15A of the spine portion 12A. At this time, when the engagement holes 16B of the ring portions 13A are pushed to the introducing portions 15i of the engagement protrusions 15A of the spine portion 12A, the engagement holes 16B can be slowly widened in the shape of the taper of the introducing portions 15i of the engagement protrusions 15A. In this way, in the ring portions 13A, the engagement holes 16B are fitted to the locking portions 15h of the engagement protrusions 15A. In the ring portions 13A, the circumferences of the engagement holes 16B are restored when the engagement holes 16B are fitted to the locking portions 15h of the engagement protrusions 15A.

As described above, the hole diameter of the engagement holes 16B of the ring portions 13A is smaller than that of the locking portions 15h of the engagement protrusions 15A. Accordingly, when the engagement holes 16B are fitted to the engagement protrusion 15A, the locking portions 15h of the engagement protrusions 15A restrain the engagement holes 16B from being detached. As a result, the ring portions 13A can be maintained in the spine portion 12A.

When the engagement hole 16B at one end of each ring portion 13A is fitted to the engagement protrusion 15A of the spine portion 12A, the ring portion 13A is bent in the loop shape. At this time, the engagement protrusion 15B at the other end of each ring portion 13A is inserted to the corresponding engagement hole 16A adjacent to the engagement protrusion 15A to which the engagement hole 16B at one end are fitted. The way how the engagement protrusions 15B of the ring portions 13A are inserted into the engagement holes 16A of the spine portion 12A is the same as that how the engagement protrusions 16B of the ring portions 13A are fitted to the engagement protrusions 15A of the spine portion 12A.

In this way, the ring portions 13A are maintained in the spine portion 12A so that the end surfaces of the ends are opposed to each other without an overlap of the ends. Thus, the ring portions 13A are bent in the loop shape, thereby binding the plural sheets of the paper 14 so as to be turned.

The plurality of binding holes 14a are punched on the sheets of paper 14. Accordingly, the ring portions 13A are inserted into all the binding holes 14a or arbitrary binding holes 14a selected if necessary and the engagement holes 16B at the one end of the ring portions 13A, as described above, are fitted to the engagement protrusion 15A and the engagement protrusions 15B at the other end thereof are inserted to the engagement holes 16A of the spine portion 12A. In this way, the loop-shaped ring portions 13A are configured.

In this case, since the engagement protrusions 15A and the engagement holes 16A of the spine portion 12A are arranged to correspond to the interval of the binding holes 14a of the sheets of paper 14, the ring portions 13A can be attached in correspondence with all the binding holes 14a and can be also attached in correspondence with the arbitrary binding holes 14a.

At this time, when the number of sheets of the paper 14 to be bound is small, the loop diameter of the ring portions 13A may be small as well. For this reason, as shown in FIG. 25A1, the ring portions 13A with the small loop diameter can be formed by using the ring portions 13A with the short length L1. Alternatively, when the number of sheets of the paper 14 to be bound is large, it is required that the loop diameter of the ring portions 13A be large. For this reason, as shown in FIG. 25B1, the ring portions 13A′ with the large loop diameter can be formed by using the ring portions 13A′ with the long length L2.

In this way, since the ring portions 13A can be selectively used depending on the number of sheets of the paper 14 to be bound among the ring portions 13A with the different lengths, it is possible to correspond to a difference in the number of sheets of the paper 14 to be bound. In addition, the spine portion 12A and the ring portions 13A are provided as components independent of each other. Accordingly, when the size of the sheets of paper 14 to be bound is equal, it is possible to correspond to the difference in the number of sheets of the paper 14 to be bound with one type of the spine portion 12A.

As a result, since the number of components be prepared in correspondence with the difference in the number of sheets of the paper 14 to be bound can be reduced, a cost can be suppressed and an inventory management of consumption goods can be easy.

Since the engagement portions of the ring portions 13A with respect to the spine portion 12A are formed at both ends of the ring portions 13A, there are no unevenness in the positions into which the ring portions 13A are inserted into the binding holes 14a of the sheets of paper 14. As a result, the exterior appearance can be improved and it is easy to turn sheets of paper.

In the binder 11A according to the sixth exemplary embodiment, in correspondence with the sheets of paper 14 in which the binding holes 14a are punched in advance in the form of having two holes, three holes, or four holes, the spine portion 12A may be formed so that any one of the plurality of engagement protrusions 15A and engagement holes 16A can correspond to the binding holes 14a of the sheets of paper 14 in which two holes, three holes, or four holes are punched in advance.

In the binder 11A, the spine portion 12A and the ring portions 13A are provided as the components independent of each other. Accordingly, by arranging the engagement protrusions 15A and the engagement holes 16A in the above-described way, one type of the spine portion 2A can be used so that the binder 1A can be provided even on paper through which 30 holes and so on are punched and even on paper through which two holes, three holes, four holes, and so on are punched.

When the spine portion 12A can be also cut depending on the size of the sheets of paper 4 to be bound, it is possible to correspond to plurality of types of different sizes (A4, B5, etc.) of the sheets of paper 14.

In the binder 11A according to the sixth exemplary embodiment, the shape of engagement protrusions 15A and 15B and the engagement holes 16A and 16B are the circle, but may be a different shape, for example, a square.

### Configuration Example Of Binder According To Seventh Exemplary Embodiment

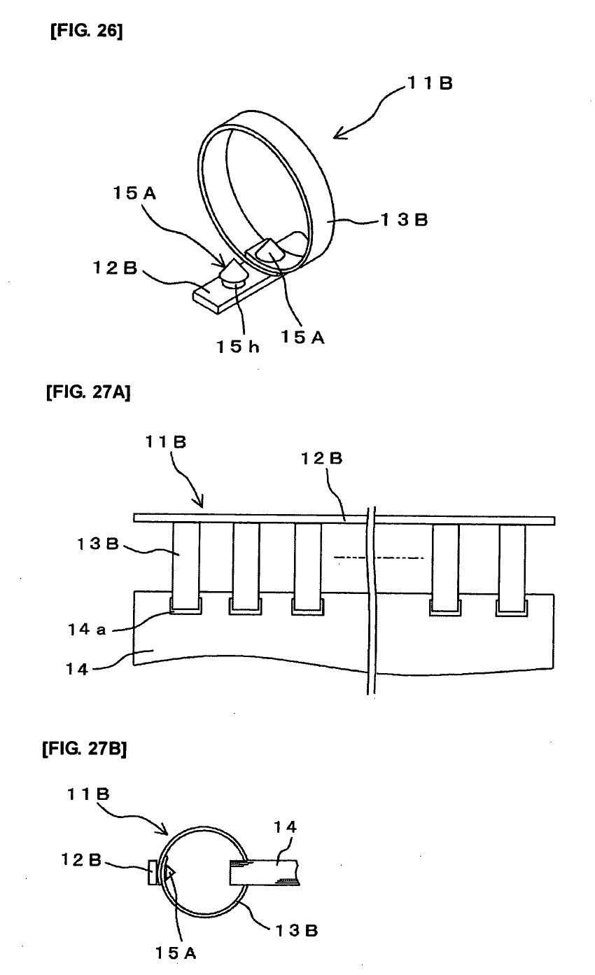

FIG. 26 is a perspective view illustrating an example of an assembled binder 11B according to a seventh exemplary embodiment. FIGS. 27A and 27B are top views illustrating an example of the binder 11B according to the seventh exemplary embodiment when it is used. FIGS. 28A and 28B are exploded block diagrams illustrating the binder 11B according to the seventh exemplary embodiment before the binder is used. In this case, the same reference numerals of the constituents of the binder 11A according to the sixth exemplary embodiment are given to those of the binder 11B according to the seventh exemplary embodiment.

The binder 11B according to the seventh exemplary embodiment includes a spine portion 12B and the ring portions 13B. The spine portion 12B is a thin plate-shaped member with a narrow width and has a length depending on the length of a paper 14 to be bound. In addition, the spine portion 12B includes plurality of engagement protrusions 15A arranged in a row in a longitudinal direction at a predetermined interval. The spine portion 12B is formed of a flexible and elastically deformable material, for example, a resin. In addition, the engagement protrusions 15 are incorporated thereto.

The engagement protrusions 15A, which are an example of the spine engagement portion, are arranged so as to correspond to the interval of the binding holes 14a formed on the sheets of paper 14, for example. The shape of the engagement protrusions 15A is the same as that of the engagement protrusions 15A described in the binder 11A according to the sixth exemplary embodiment and the locking portions 15h in which the introducing portions 15i are formed are provided at the front end of the engagement protrusions 15A. However, the height of a part to which the ring portion 13B of the engagement protrusion 15A is fitted is configured to be about twice as long as the thickness of the ring poring 13B.

As shown in FIG. 27A, each ring portion 13B is a thin plate-shaped member having a sufficient width to be inserted into the binding hole 14a of the sheets of paper 14. As shown in FIG. 28B, the plurality of engagement holes 16B are arranged only at both ends in the longitudinal direction. The ring portions 13B are formed of a flexible and elastic deformable material such as a resin, and the engagement protrusions 16B are formed therethrough.

The engagement holes 16B, which are an example of the ring engagement portion, are circular in shape and the engagement protrusions 15A of the spine portion 12B are inserted thereinto as shown in FIG. 28B. The hole diameter of each engagement hole 16B is configured to be smaller than that of each locking portion 15h of the engagement protrusion 15A.

### Use Example of Binder According To Seventh Exemplary Embodiment

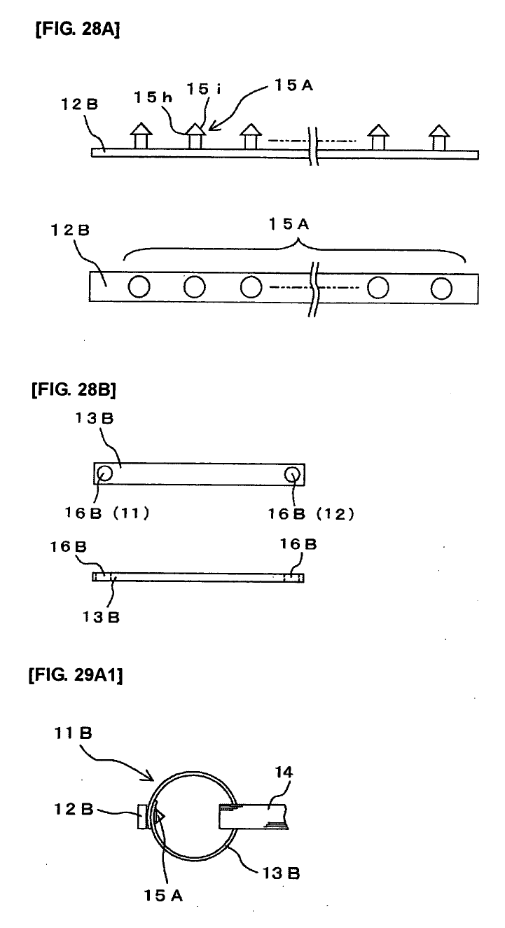

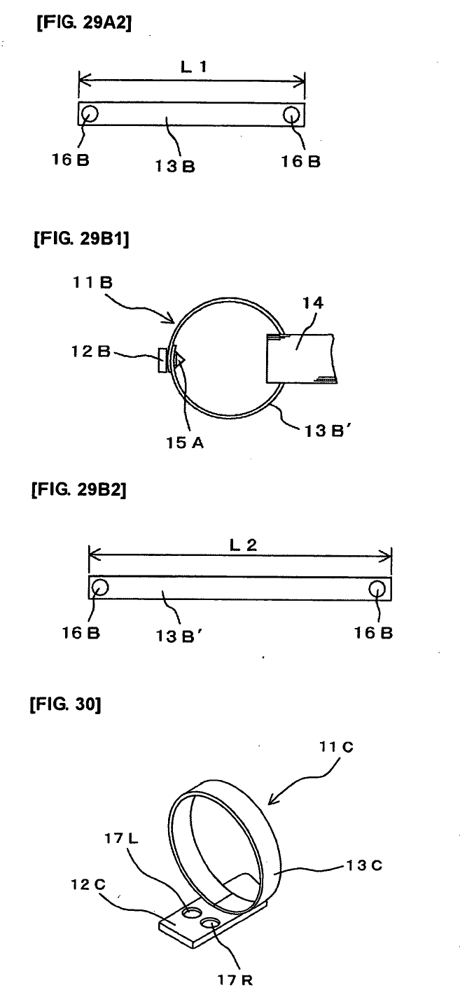

FIGS. 29A1 and 29B2 are exemplary block diagrams illustrating the binder 11B according to the seventh exemplary embodiment. Next, the bind 11B according to the seventh exemplary embodiment will be described with reference to FIGS. 26 to 29B. In this case, FIGS. 29A1 and 29A2 show a case where the number of sheets of a paper 14 to be bound is small and FIGS. 29B1 and 29B2 show a case where the number of sheets of the paper 14 is large.

First, the spine portion 12B and the ring portions 13B are provided independently each other. The plurality of types of the ring portions 13B having different lengths depending on the number of sheets of the paper 14 to be bound are prepared. When the number of sheets of the paper 14 to be bound is small, as shown in FIG. 29A1, the ring portions 13B having the short length L1 are used as shown in FIG. 29A2. Alternatively, when the number of sheets of the paper 14 to be bound is large, as shown in FIG. 29B1, the ring portions 13B′ having the long length L2 are used as shown in FIG. 29B2.

For example, each the ring portion 13B passes through the corresponding binding hole 14a of the sheets of paper 14. In addition, the engagement hole 16B(1) at the one end of each ring portion 13B are fitted to the engagement protrusion 15A placed in a predetermined position of the spine portion 12B.

When the engagement holes 16B of the ring portions 13B are fitted to the engagement protrusions 15A of the spine portion 12B, the engagement holes 16B of the ring portion 13B are slowly widened in the shape of the taper of the introducing portions 15i like the use example of the binder 11A according to the sixth exemplary embodiment. At this time, the engagement holes 16B are fitted to the locking portions 15h of the engagement protrusions 15A. In the ring portions 13B, the circumferences of the engagement holes 16B are restored when the engagement holes 16B are fitted to the locking portions 15h of the engagement protrusions 15A.

As described above, the hole diameter of the engagement holes 16B of the ring portions 13B is smaller than that of the locking portions 15h of the engagement protrusions 15A. Accordingly, when the engagement holes 16B are fitted to the engagement protrusion 15A, the locking portions 15h of the engagement protrusions 15A restrain the engagement holes 16B from being detached. As a result, the ring portions 13B can be maintained in the spine portion 12B.

When the engagement hole 16B(1) at one end of each ring portion 13B is fitted to the engagement protrusion 15A of the spine portion 12B, the ring portion 13B is bent in the loop shape. At this time, the engagement hole 16B(2) at the other end of each ring portion 13B is fitted to the engagement hole 16B(1) at the one end and the same engagement protrusion 15A.

The height of a part of the engagement protrusion 15A to which the ring portion 13B is fitted is substantially equal to the thickness of two pieces of the ring portions 13B. Accordingly, when the engagement hole 16B(1) at one end of the ring portion 13B is fitted to the engagement protrusion 15A of the spine portion 12B and the engagement hole 16B(2) at the other end of the same ring portion 13B is fitted to the same engagement protrusion 15A, as described above, the ring portion 13B is fitted to one engagement protrusion 15B so that both end thereof are overlapped with each other.

Since the ring portions 13B are bent in the loop shape, the plural sheets of the paper 14 are bound so as to be turned. The plurality of binding holes 14a are punched on the sheets of paper 14. Accordingly, the ring portions 13B are inserted into all the binding holes 14a or arbitrary binding holes 14a selected if necessary and the engagement holes 16B, as described above, are fitted to the engagement protrusion 15A in the form of overlapping both ends of the ring portions 13B with each other. In this way, the loop-shaped ring portions 13B are configured.

In this case, since the engagement protrusions 15A of the spine portion 12B are arranged to correspond to the interval of the binding holes 14a of the sheets of paper 14, the ring portions 13B can be attached in correspondence with all the binding holes 14a and can be also attached in correspondence with the arbitrary binding holes 14a.

At this time, when the number of sheets of the paper 14 to be bound is small, the loop diameter of the ring portions 13B may be small as well. For this reason, as shown in FIG. 29A1, the ring portions 13B with the small loop diameter can be formed by using ring portions 13B with a short length L1. Alternatively, when the number of sheets of the paper 14 to be bound is large, it is required that the loop diameter of the ring portions 13B be large. For this reason, as shown in FIG. 29B1B, the ring portions 13B′ with the large loop diameter can be formed by using the ring portions 13B′ with a long length L2.

In this way, since the ring portions 13B are selectively used depending on the number of sheets of the paper 14 to be bound among the ring portions 13B with different lengths like the binder according to the sixth exemplary embodiment, it is possible to correspond to a difference in the number of sheets of the paper 14 to be bound. In addition, the spine portion 12B and the ring portions 13B are provided as components independent of each other. Accordingly, when the size of the sheets of paper 14 to be bound is equal, it is possible to correspond to the difference in the number of sheets of the paper 14 to be bound with one type of the spine portion 12B.

Accordingly, since it is possible to reduce the number of the type of the components to be prepared in correspondence with the difference in the number of sheets of the paper to be bound, a cost can be suppressed and an inventory management of consumption goods or the like can be easy.

Since the engagement portions of the spine portion 12B with respect to the ring portions 13B are formed in a row, it is possible to narrow the width of the spine portion 12B.

In the binder 11B according to the seventh exemplary embodiment, the shapes of the engagement protrusions 15A and the engagement holes 16B are the circle, but may be a different shape, for example, a square. In addition, a part of each engagement hole 16B that is an end of the ring portion 13B in a circumference direction may be opened.

### Configuration Example Of Binder According To Eighth Exemplary Embodiment

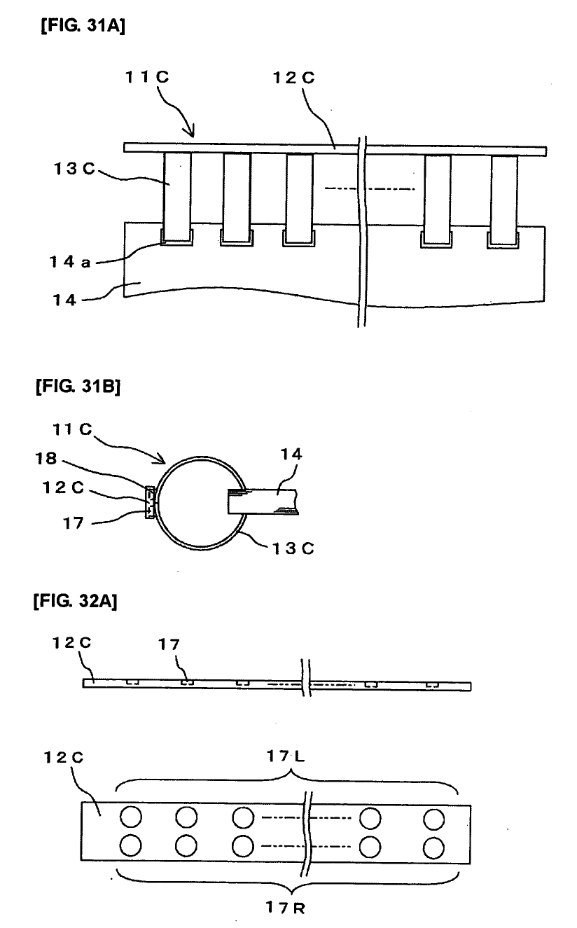

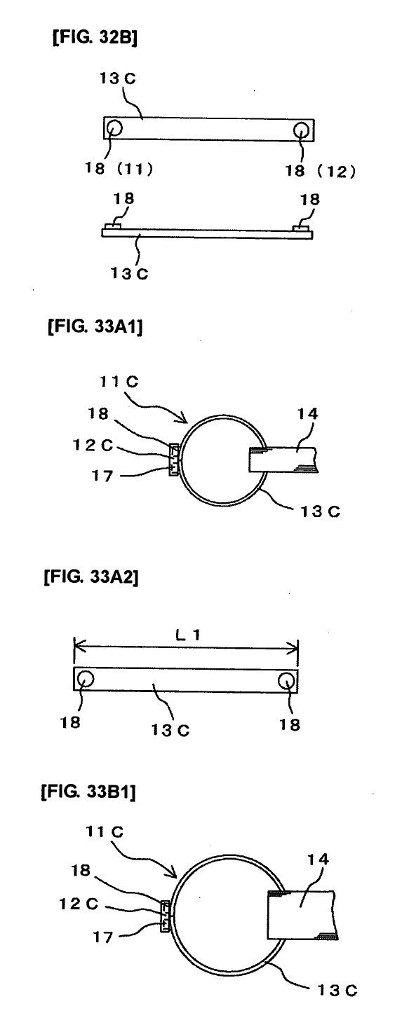

FIG. 30 is a perspective view illustrating an example of an assembled binder 11C according to an eighth exemplary embodiment. FIGS. 31A and 31B are front views illustrating an example of the binder 11C according to the eighth exemplary embodiment when the binder is used. FIGS. 32A and 32B are exploded block diagrams illustrating the binder 11C according to the eighth exemplary embodiment before the binder is used.

The binder 11C according to the eighth exemplary embodiment includes a spine portion 12C and ring portions 13C. The spine portion 12C is a thin plate-shaped member with a narrow width and has a length depending on the length of a paper 14 to be bound. For example, the spine portion 12C includes a first row of engagement holes 17L arranged in a row in a longitudinal direction at an interval to correspond to the binding holes 14a of the sheets of paper 14 and a second row of engagement holes 17R arranged in parallel with the first row of the engagement holes 17L at the same interval as the first engagement holes 17L. The spine portion 12C is formed of a flexible and elastically deformable material, for example, a resin. In addition, the engagement holes 17L and 17R are formed of a concave shape.

The engagement holes 17L and 17R are examples of the spine engagement portions and the transverse section thereof has, for example, a circular shape to correspond to the shape of the engagement protrusion 18 formed in the ring portions 13C.

As shown in FIG. 31A, each ring portion 13C is a thin plate-shaped member having a sufficient width to be inserted into the corresponding binding hole 14a of the sheets of paper 14. As shown in FIG. 32B, the plurality of engagement protrusions 18 are formed only at both ends in a longitudinal direction. The ring portions 13C are formed of a flexible and elastically deformable material such as a resin and the engagement protrusions 18 are incorporated thereinto.

The engagement protrusions 18, which are an example of the ring engagement portion, are cylindrical in shape so as to be inserted into the engagement holes 17L and 17R of the spine portion 12C. The diameter of the engagement protrusions 8 is slightly larger than that of the engagement holes 17L and 17R. The engagement protrusions 18 are configured to be press-inserted into the engagement holes 17L and 17R.

### Use Example of Binder According To Eighth Exemplary Embodiment

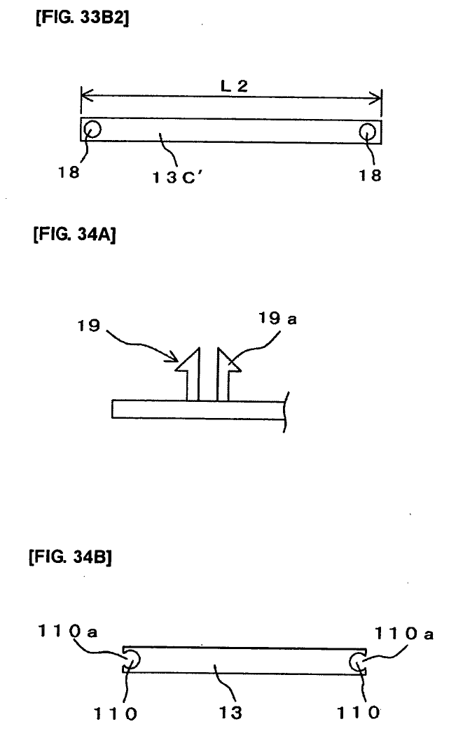

FIGS. 33A1 and 33B2 are exemplary block diagrams illustrating the binder 11C according to the eighth exemplary embodiment. Next, the bind 11C according to the eighth exemplary embodiment will be described with reference to FIGS. 30 to 33B2. FIGS. 33A1 and 33A2 show a case where the number of sheets of a paper 14 to be bound is small and FIGS. 33B1 and 33B2 show a case where the number of sheets of the paper 14 is large.

The spine portion 12C and the ring portions 13C are provided independently from each other. The plurality of types of the ring portions 13C with different lengths deepening on the number of sheets of the paper 14 to be bound are prepared. When the number of sheets of the paper 14 to be bound is small, as shown in FIG. 33A1, the ring portion 13C with a short length L1 is used, as shown in FIG. 33A2. Alternatively, when the number of sheets of the paper 14 to be bound is large, as shown in FIG. 33B1, the ring portions 13C′ with a long length L2 is used, as shown in FIG. 33B2.

For example, the ring portions 13C pass through the binding holes 4a of the sheets of paper 14. In addition, the engagement protrusion 18(1) at one end of the ring portion 13C is press-inserted into the engagement hole 17L placed in a first row of a predetermined position of the spine portion 12C.

When the engagement protrusions 18 of the ring portions 13C are inserted into the engagement holes 17L of the spine portion 12C, one ends of the ring portions 13C are maintained in the spine portion 12C.

When the engagement protrusions 18(1) at the one ends of the ring portions 13C are press-inserted into the first row of the engagement holes 17L of the spine portions 12C, the ring portions 13C are bent in the loop shape. At this time, the engagement protrusions 18(2) at the other end of the ring portions 13C are press-inserted into the second row of the engagement holes 17R adjacent to the first row of the engagement holes 17L into which the engagement protrusions 8(1) at the one ends thereof are inserted.

In this way, the ring portions 13C are maintained in the spine portion 12C so that the end surfaces at both ends are opposed to each other without an overlap of the ends. Thus, the ring portions 13C are bent in the loop shape, thereby binding the plural sheets of the paper 14 so as to be turned.

The plural binding holes 14a are punched on the sheets of paper 14. Accordingly, the ring portions 13C are inserted into all the binding holes 14a or arbitrary binding holes 14a selected if necessary and the engagement holes 18(1) at one ends of the ring portions 13C, as described above, are fitted to the first row of the engagement holes 17L and the engagement holes 18(2) at the other ends of the ring portions 13C are inserted into the second row of the engagement holes 17R. In this way, the loop-shaped ring portions 13C are configured.

In this case, since the engagement holes 17L and 17R of the spine portion 12C are arranged to correspond to the interval of the binding holes 14a of the sheets of paper 14, the ring portions 13C can be attached in correspondence with all the binding holes 14a and can be also attached in correspondence with the arbitrary binding holes 14a.

At this time, when the number of sheets of the paper 14 to be bound is small, the loop diameter of the ring portions 13C may be small as well. For this reason, as shown in FIG. 33A1, the ring portions 13C with the small loop diameter can be formed by using the ring portions 13C with a short length L1. Alternatively, when the number of sheets of the paper 14 to be bound is large, it is required that the loop diameter of the ring portions 13C be large. For this reason, as shown in FIG. 33B1, the ring portions 13C′ with the large loop diameter can be formed by using the ring portions 13C′ with a long length L2.

In this way, since the ring portions 13C can be selectively used depending on the number of sheets of the paper 14 to be bound in the same way in the binder according to the sixth exemplary embodiment among the ring portions 13C with different lengths, it is possible to correspond to a difference in the number of sheets of the paper 14 to be bound with one type of the ring portions 3D. In addition, the spine portion 12C and the ring portions 13C are provided as components independent of each other. Accordingly, when the size of the sheets of paper 14 to be bound is equal, it is possible to correspond to the difference in the number of sheets of the paper 14 to be bound with one type of the spine portion 12C.

Accordingly, since it is possible to reduce the number of the type of the components to be prepared in correspondence with the difference in the number of sheets of the paper to be bound, a cost can be suppressed and an inventory management of consumption goods or the like can be easy.

The shapes of the engagement holes 17L and 17R and the engagement protrusions 18 are the circle, but may be a different shape, for example, a square. In addition, two rows of the engagement protrusions may be provided in the spine portion 12C and the engagement holes fitted to both ends of the ring portions 13C may be provided.

### <Modified Example of Engagement Protrusion and Engagement Hole>

FIGS. 34A and 34B are block diagrams illustrating a modified example of an engagement protrusion and an engagement hole according to each exemplary embodiment. The shape of the engagement protrusions and the engagement holes is the circle in each exemplary embodiment, but may be other shapes such as a square. For example, the shape of the transverse section of an engagement protrusion 19 formed in the spine portion or the ring portion is a square as shown in FIG. 34A. In addition, the engagement protrusion 19 may be provided as a member with two hooked shape provided with a locking portion 19a on the front end. When the transverse section of the engagement protrusion 19 is square in shape, the engagement hole is configured to be square in shape.

For example, as a modified example of the ring portion 13B of the binder 11B according to the seventh exemplary embodiment, an engagement hole 110 may be provided with an opening 110a by opening a part of the circumference that is the end of a ring portion 103 as shown in FIG. 34B.

The invention is described in detail and with reference to the specific embodiments. However, it is apparent for a person skilled in the art that the embodiments may be modified into various forms without departing from the spirit or scope of the invention.

This application is based on Japanese Patent Application No. 2005-139122 filed on May 11, 2005 and Japanese Patent Application No. 2005-139123 filed on May 11, 2005, contents of which are hereby incorporated by reference.

### INDUSTRIAL APPLICABILITY

The invention is applicable to a multi-hole binder that binds paper through which binding holes are punched.

1. A binder comprising:
ring portions to be inserted into binding holes formed in a plurality of sheets of paper so as to bind the sheets of paper; and
a spine portion which is configured by a member independent from the ring portions and to which the ring portions are attached,
wherein each ring portion includes ring engagement portions, which are attached to the spine portion, at least at both ends including one end and the other end in a longitudinal direction of the ring portion, and
the spine portion includes spine engagement portions corresponding to the binding holes in the sheets of paper, wherein the ring engagement portions at the both ends of the ring portions wound in loop-shapes are attached to the spine engagement portions.

2. The binder according to claim 1, wherein the each ring portion includes a plurality of ring engagement portions arranged in the longitudinal direction of the each ring portion.

3. The binder according to claim 1, wherein the each ring portion has the ring engagement portions only at the both ends in the longitudinal direction of the each ring portion.

4. The binder according to claim 1, wherein each ring engagement portion has an engagement protrusion protruding in a convex shape, and
each spine engagement portion has a concave engagement hole into which the engagement protrusion is fitted.

5. The binder according to claim 1, wherein each spine engagement portion has an engagement protrusion protruding in a concave shape and,
each ring engagement portion has a concave engagement hole into which the engagement protrusion is fitted.

6. The binder according to claim 5, wherein an engagement hole at the one end and an engagement hole at the other end which are overlapping by winding the ring portion in the loop-shape are fitted to the engagement protrusion, so as to attach the ring portion to the spine portion.

7. The binder according to claim 1, wherein the spine engagement portions are arranged in two rows, and
wherein the ring engagement portion at the one end of each loop-shaped ring portion is attached to the spine engagement portion at one row and the ring engagement portion at the other end thereof is attached to the spine engagement portion in the other row, so as to attach the ring portion to the spine portion.

8. The binder according to claim 1, wherein the ring portions are cut in a length depending on the number of sheets to be bound, and
the ring engagement portions at the one end and the other end of each loop-shaped ring portion are attached to the spine engagement portion, so as to attach the ring portion to the spine portion.
